(19) United States
(12) Patent Application Publication
(10) Pub. No.: US 2024/0406117 A1
(43) Pub. Date: Dec. 5, 2024

(54) VIRTUAL-TIME RATE FOR MANAGING QUEUES

(71) Applicant: Hewlett Packard Enterprise Development LP, Spring, TX (US)

(72) Inventors: Jean Tourrilhes, Mountain View, CA (US); Puneet Sharma, Palo Alto, CA (US)

(21) Appl. No.: 18/498,460

(22) Filed: Oct. 31, 2023

Related U.S. Application Data
(60) Provisional application No. 63/470,730, filed on Jun. 2, 2023.

(51) Int. Cl. H04L 47/625; H04L 47/122; H04L 47/2483

(52) U.S. Cl. CPC H04L 47/6255; H04L 47/122; H04L 47/2483

(57) ABSTRACT

A system maintains a queue structure used for storing packets and comprising a plurality of sub-queues used to process the packets, wherein the packets in the queue structure are to be dequeued by a scheduler. The system computes a respective packet virtual time for a respective packet based on at least a packet virtual time of a previous packet processed by the same sub-queue. The system computes a global virtual time based on a packet virtual time of a packet being dequeued from the queue structure. The system measures a rate at which the global virtual time progresses based on the virtual time of packets dequeued from the queue structure. The system manages congestion in the sub-queues based on the rate at which the global virtual time progresses, a metric of a respective sub-queue, and an amount of a resource for the queue structure.

### RELATED APPLICATION

This application claims the benefit of U.S. Provisional Application No. 63/470,730, Attorney Docket Number P171955USPRV, entitled “VIRTUAL-TIME RATE,” by inventors Jean Tourrilhes and Puneet Sharma, filed 2 Jun. 2023.

### BACKGROUND

### Field

Network devices may have a finite amount of memory, which can limit queue structures in storing packets waiting to be forwarded. As network devices develop (e.g., an increasing number of ports and port rate), more buffers for storing packets waiting to be forwarded may be required. As a result, the limited resource of packet buffers must be shared efficiently and fairly amongst various queues of the queue structures of a network device. In addition, allocation of the resources can affect congestion management, which can be an important factor in the performance of the network device.

### BRIEF DESCRIPTION OF THE FIGURES

FIG. 1 illustrates an environment which includes a Quality of Service (QoS) controller for scheduling packets, in accordance with an aspect of the present application.

FIG. 2 illustrates an environment which includes a classifier, a plurality of sub-queues, and a scheduler, in accordance with an aspect of the present application.

FIG. 3 illustrates an environment which facilitates managing queues based on a virtual time rate and a scaled metric, in accordance with an aspect of the present application.

FIG. 4 illustrates an environment which facilitates managing queues based on a virtual time rate for buffer management, in accordance with an aspect of the present application.

FIG. 5 illustrates an environment which facilitates managing queues based on a virtual time rate for active queue management (AQM), in accordance with an aspect of the present application.

FIG. 6 illustrates an environment which facilitates managing queues based on a virtual time rate with a Priority In First Out (PIFO) or an Admission In First Out (AIFO) queue, in accordance with an aspect of the present application.

FIG. 7 presents a flowchart illustrating a method which facilitates managing queues based on a virtual time rate, in accordance with an aspect of the present application.

FIG. 8 illustrates a computer system which facilitates managing queues based on a virtual time rate, in accordance with an aspect of the present application.

In the figures, like reference numerals refer to the same figure elements.

### DETAILED DESCRIPTION

Aspects of the instant application provide a system which facilitates managing congestion and allocating resources to a plurality of sub-queues of a queue structure using a “Virtual-Time Rate” mechanism, which can be based on a rate of virtual time of packets dequeued from the queue structure over a predefined time period, a rate of packets dequeued from the queue structure over the predefined time period, and other factors.

Network devices may have a finite amount of memory, which can limit “queue structures” in storing packets waiting to be forwarded. As network devices develop (e.g., an increasing number of ports and port rate), more “packet buffers” for storing packets waiting to be forwarded may be required. A queue structure can refer to a data structure for enqueuing packets and can include one or more queues or sub-queues, and a packet buffer can refer to a memory space allocated for enqueuing packets into a queue or sub-queue of the queue structure. As a result, the limited resource of packet buffers must be shared efficiently and fairly amongst various queues of a network device. In addition, allocation of the resources can affect congestion management, which can be important factor in the performance of the network device.

Dynamic Buffer Management (DBM) techniques can enable a dynamic allocation of buffers to the sub-queues of a complex queue structure based on its current state, ensuring that no sub-queue can starve and that buffer allocation is not wasted on idle sub-queues.

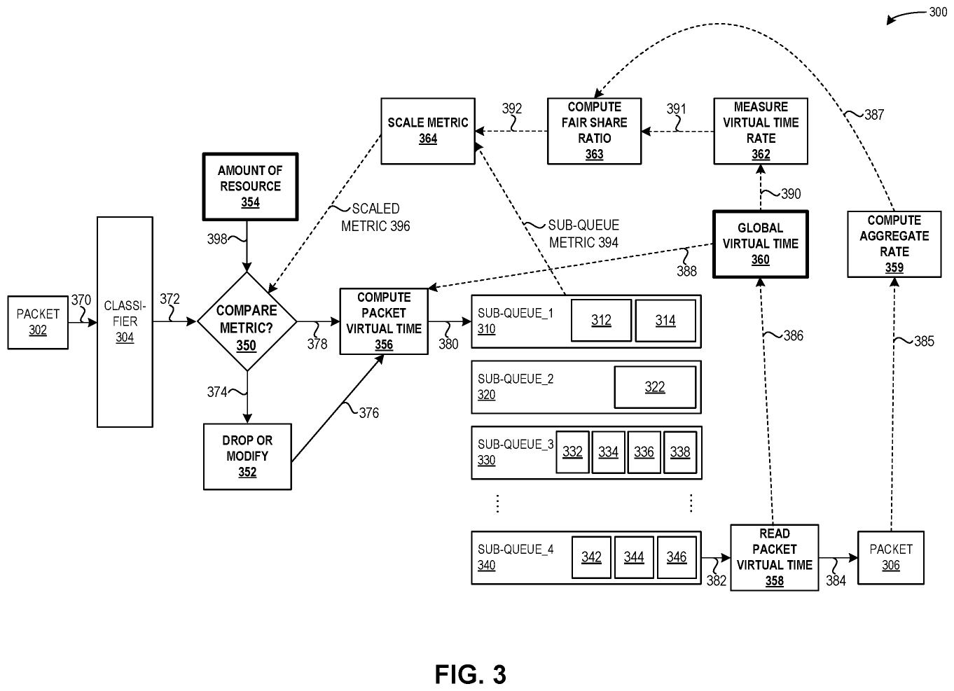

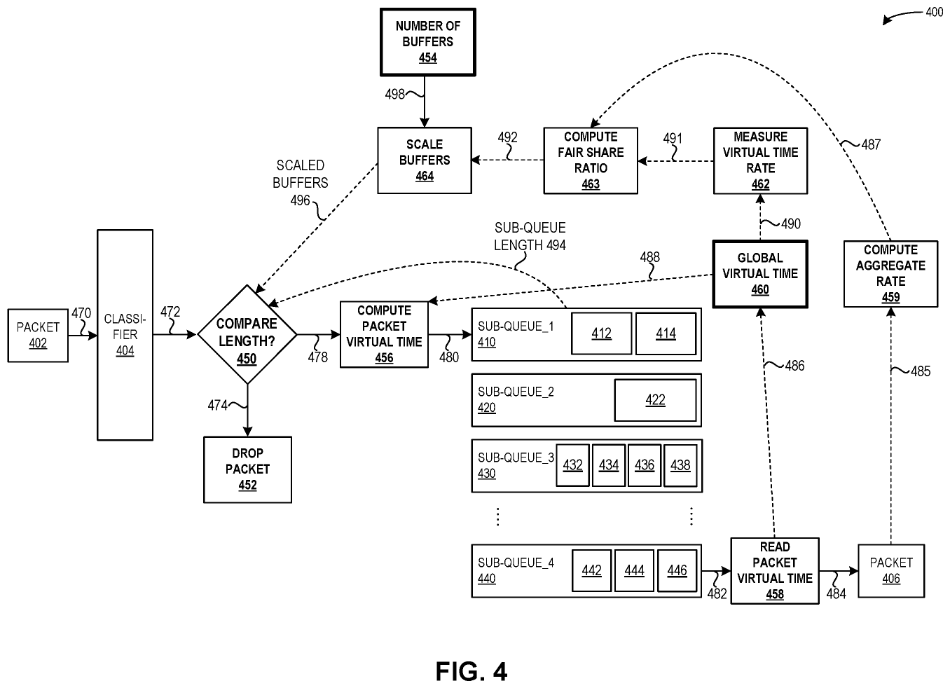

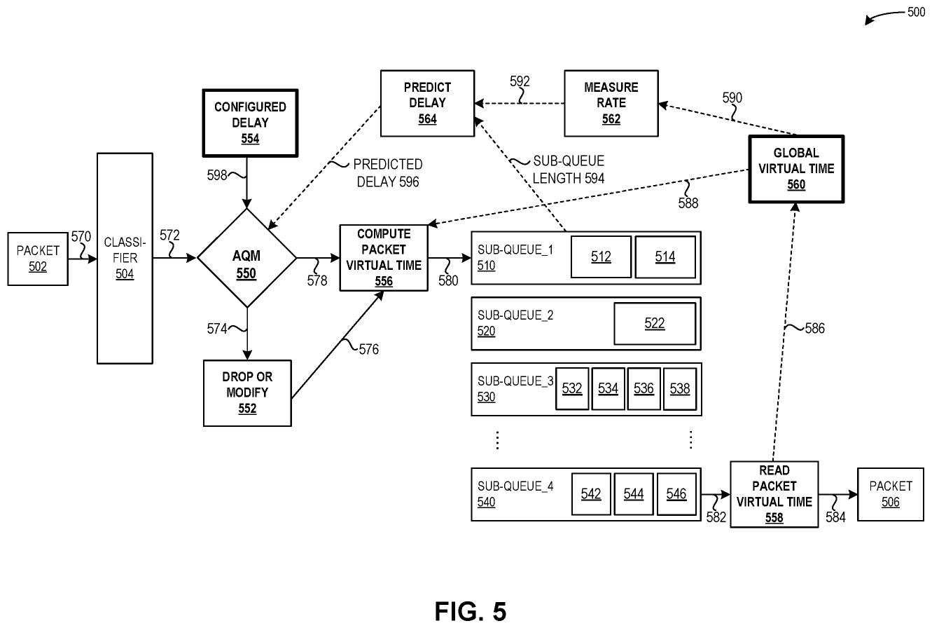

Aspects of the instant application provide a system and method which facilitate a DBM mechanism which is simpler than current DBM mechanisms while also providing more predictable performance. The described system, referred to in this disclosure as the “Virtual-Time Rate” mechanism (or “VTR”), can use a fair scheduler to aid in fairly allocating buffers between sub-queues. VTR can also be used for many Active Queue Management (AQM) schemes or flow control schemes on sub-queues. The described aspects of VTR can compute a “global virtual time” based on a packet being dequeued from any sub-queue of the plurality of sub-queues, and can further compute a rate at which the global virtual time progresses based on packets dequeued by a scheduler, e.g., over a predefined time period, from all the sub-queues (“global virtual time rate”). VTR can thus manage congestion in and allocate resources to the sub-queues using the measured global virtual time rate, an amount of a resource for the queue structure, and a sub-queue metric (e.g., a sub-queue size like a number of packets or bytes), as described below in relation to FIG. 3. VTR can also use the measured rate to dynamically compute a maximum queue size for the sub-queues and to compute a queue delay that can be used in AQM and flow control techniques, as described below in relation to, respectively, FIGS. 4 and 5.

The term “queue structure” can refer to a data structure for enqueuing and storing packets, which includes a plurality of sub-queues used for processing packets, where the packets are dequeued by a scheduler. In most cases, the sub-queues are used for enqueuing and storing the packets.

The term “packet virtual time” can indicate a relative order of processing based on a configured weight for a sub-queue into which the packet is to be placed and a size of the respective packet or another packet in the sub-queue. For example, the packet virtual time can be based on the virtual time associated with a packet previously processed by the same sub-queue and can be a start time or a finish time associated with the packet. The virtual time of a packet may be computed upon being enqueued in the queue structure or dequeued from the queue structure. The packet virtual time may be read from the packet upon being dequeued from the queue structure.

The term “global virtual time” can be based on a packet virtual time of a packet being dequeued from the queue structure. The term “global virtual time rate” can refer to a rate at which the global virtual time progresses based on the virtual time of packets dequeued by the scheduler. This rate can usually be computed over a predefined time period; however, other computations may be possible.

The term “aggregate time” can be based on the total number of packets or total packet sizes dequeued by the scheduler from the queue structure. The terms “aggregate rate” and “aggregate time rate” are used interchangeably in this disclosure and can refer to a rate at which the aggregate time progresses. This rate can usually be computed over a predefined time period; however, other computations may be possible.

The term “sub-queue metric” can refer to a measurement or other unit or quantity associated with a sub-queue and which can be used, along with the global virtual time rate, to manage congestion in and allocate resources to the sub-queues. Examples of a sub-queue metric can include, but are not limited to: a length of a sub-queue; a difference between the virtual time of the packet at the tail of the sub-queue and the current global virtual time; and a delay associated with packets progressing through a sub-queue.

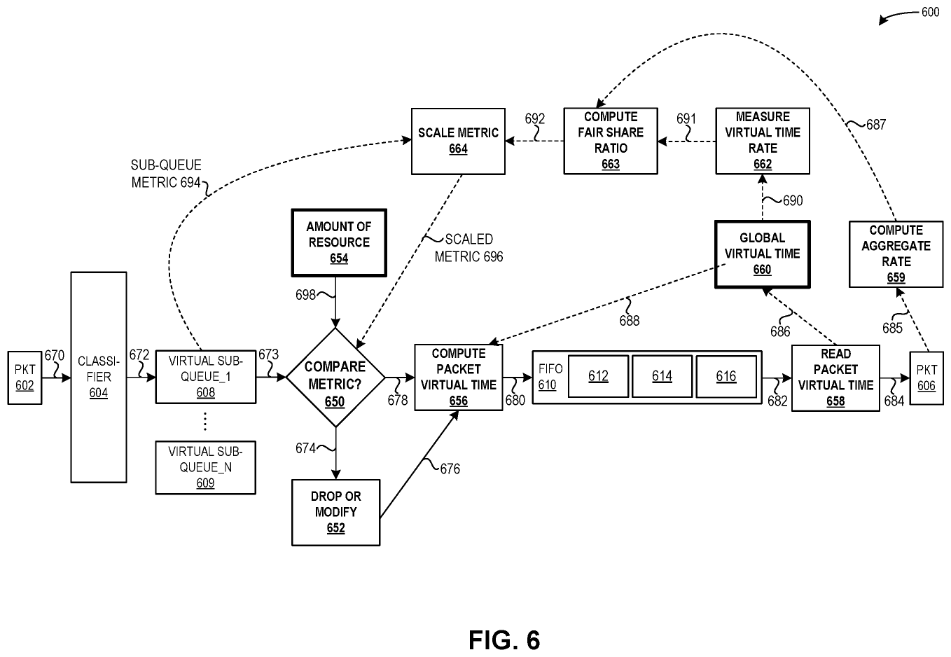

The term “Fair Share Ratio” is used in this disclosure to refer to the ratio of the global virtual time rate to the aggregate time rate. This ratio can usually be computed over a predefined time period. An example of applying the Fair Share Ratio is described below in relation to FIGS. 3 and 6.

The term “Virtual-Time Rate” and its abbreviation “VTR” are used interchangeably in this disclosure and refer to the overall system described, e.g., in relation to FIGS. 3-7, which system is also referred to as the VTR mechanism, technique, or system.

### Network Queues, Congestion, Sub-Queues, and Schedulers

Network devices (e.g., routers, switches, etc.) may have multiple network links connected to them. A network device can enable the connection of multiple network links to each other and can also forward incoming traffic to the proper outgoing link. Each link may have a finite outgoing capacity and can transmit only one packet at a time. The traffic to be forwarded on a link may arrive from many links and may be unpredictable or bursty. One current solution to handle the mismatch between these incoming and outgoing properties is to implement a queue on the outgoing interface of each link. The queue can store incoming bursts of traffic, and the outgoing interface can send traffic on the link from the queue at the appropriate pace (usually as fast as the link is capable). Thus, a queue can accommodate a temporary excess in input rate by storing packets and smoothing out the processing at the outgoing link.

Networks may be shared by many network applications, which may use different manners of sharing network resources between the applications. One manner is a “best effort” policy, in which the sharing between applications is not managed and instead is only concerned by the overall efficiency of the network. Another manner is “fairness,” which attempts to split some characteristics of the network as equally as possible. Examples of types of fairness may include an equal number of packets, an equal bandwidth, or an equal queuing delay. Yet another manner is network “quality of service” (QoS), which attempts to enforce a QoS policy configured by an administrator of the network. As an example, a QoS policy may define priorities, where applications with higher priority may receive preferential treatment over applications with lower priority. As another example, a QoS policy may limit some of the applications or reserve resources for some of the applications. In general, most networks can implement a mix of these different manners of sharing network resources between the applications.

As described above, congestion at a queue may occur when the traffic originators sending traffic through a queue collectively attempt to send more traffic than the amount of traffic that the queue can process and forward. If the queue is not congested, each user can send as much traffic as desired, in which case neither fairness nor QoS is an issue. However, if the queue is congested, each user may not be able to send as much traffic as desired, in which case both fairness and QoS may be a concern.

As a result, queue congestion may strongly affect the fairness and QoS of the network as a whole. A simple queue may only provide a best effort service. More complex queues may implement fairness for traffic going through the bottleneck, e.g., by giving various traffic flows equal treatment. Other complex queues may implement and enforce QoS policies amongst QoS classes.

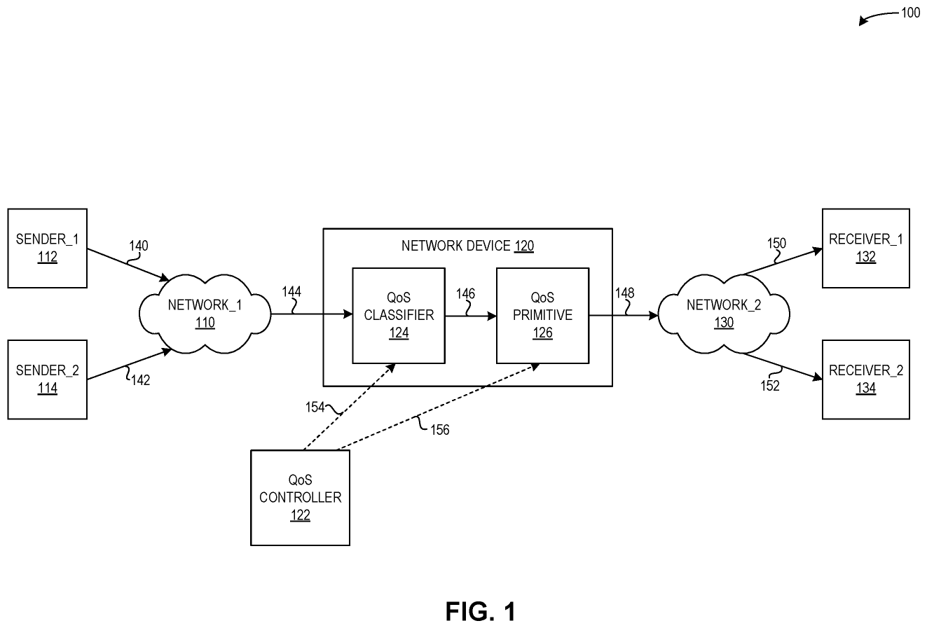

FIG. 1 illustrates an environment 100 which includes a QoS controller 122 for scheduling packets, in accordance with an aspect of the present application. Environment 100 can include multiple network senders which send data to multiple network receivers, where the data may pass through multiple networks and at least one network device. For example, a sender_1 112 and a sender_2 114 can send data (via, respectively, communications 140 and 142) destined for a receiver_1 132 and a receiver_2 134. The data can pass through a network_1 110 to a network device 120 (via a communication 144) and through a network_2 130 (via a communication 148) before being sent onwards to receivers 132 and 134 (via, respectively, communications 150 and 152). Communications 140, 142, 144, 146, 148, 150, and 152 may occur via, e.g., a wired or wireless communication. Network device 120 can include hardware or software or a combination of hardware and software. Network device 120 can include logic, circuits, elements, units, components, and modules, in hardware or software or a combination, such as a QoS classifier 124 and a QoS primitive 126.

Network device 120 can also include or be associated with a QoS controller 122, which can reside in network device 120 or be accessed or used from a location remote from or external to network device 120. QoS controller 122 may be implemented in hardware or software or a combination of hardware and software. QoS controller 122 can send QoS configurations to both QoS classifier 124 and QoS primitive 126 (via, respectively, communications 154 and 156). QoS classifier 124 can be configured to classify data received from network_1 110 into one of a plurality of classes, where a class can correspond to a certain sub-queue of a plurality of sub-queues. That is, QoS classifier 124 can assign a class to a packet and enqueue the packet into a sub-queue based on the assigned class for the packet. QoS primitive 126 can be configured to dequeue or schedule packets from the sub-queues based on certain policies, including fairness (e.g., an equal number of packets, bytes/bandwidth, and latency for all users) and QoS (e.g., differently allocated bandwidth and latency to users based on priority, percentage, etc.). Congestion may occur in network device 120 at the point of dequeuing, thus the order in which packets received via 144 are dequeued or scheduled (by QoS primitive 126) and subsequently transmitted via 148 can be critical in enforcing fairness and QoS.

One main technique to implement network fairness or network QoS is to use a complex queue structure (e.g., with multiple sub-queues) and a scheduler. The system (or a user) can assign each traffic class or traffic flow to a particular sub-queue. When the queue structure receives a packet, a classifier can select the sub-queue into which to place the packet (e.g., based on packet headers). In the case of First-In-First-Out (FIFO) queues, packets can be enqueued at the tail of a sub-queue. Upon dequeuing, the scheduler can scan the sub-queues and select a sub-queue and the corresponding packet (or packets) at the head of the selected sub-queue. In selecting the sub-queue, the scheduler decides the order in which packets are processed and forwarded. The scheduler can ensure that each traffic class or traffic flow is handled fairly. Given a suitable set of sub-queues, classifier, and scheduler, complex and elaborate QoS policies can be effectively implemented.

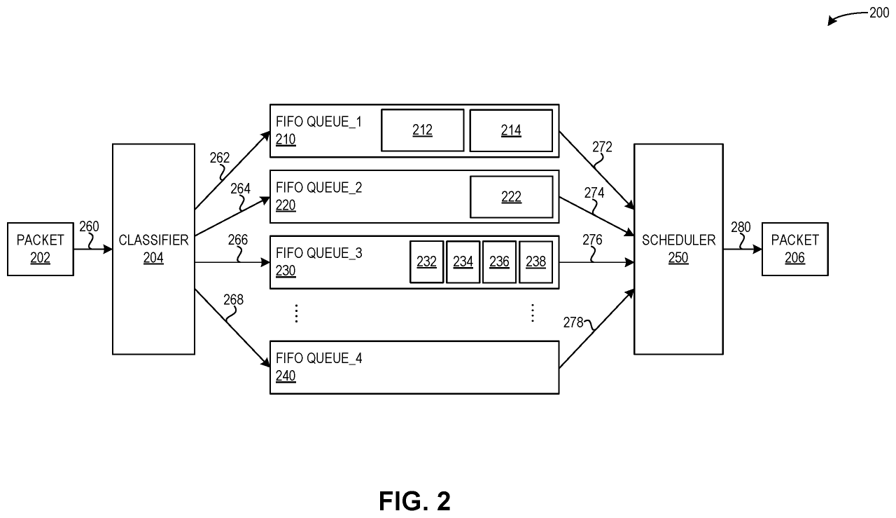

FIG. 2 illustrates an environment 200 which includes a classifier 204, a plurality of sub-queues 210, 220, 230, and 240, and a scheduler 250, in accordance with an aspect of the present application. Classifier 204, sub-queues 210-240, and scheduler 250 may be implemented in hardware or software or a combination of hardware and software and can correspond to QoS controller 122, QoS classifier 124, and QoS primitive 126 of FIG. 1. Sub-queues 210, 220, 230, and 240 can be first in, first out (FIFO) queues. Each queue can be associated with a particular class and include zero or more packets. For example: FIFO queue_1 210 can include at least packets 212 and 214; FIFO queue_2 220 can include at least a packet 222; FIFO queue_3 230 can include at least packets 232, 234, 236, and 238; and FIFO queue_4 240 can include no packets. Environment 200 may include a fewer or greater number of sub-queues than as illustrated in FIG. 2.

In environment 200, a packet 202 can be received by classifier 204 (depicted by an arrow 260), which can assign a class to packet 202. Packet 202 (along with other assigned packets) can be enqueued at the end (i.e., the tail) of one of sub-queues 210, 220, 230, and 240 (the enqueuing depicted respectively by arrows 262, 264, 266, and 268) based on the assigned class. Scheduler 250 can determine, based on configured policies to enforce fairness and QoS, an order in which to dequeue the packets of sub-queues 210, 220, 230, and 240 (the dequeuing depicted respectively by arrows 272, 274, 276, and 278). After a packet is dequeued, based on the order determined by scheduler 250, the packet can be forwarded, e.g., as a packet 206 (depicted by an arrow 280).

Thus, environment 200 depicts multiple sub-queues (210, 220, 230, and 240) that store packets which are directed to and enqueued into the sub-queues based on a classification or class assigned by the classifier (204). The scheduler (250) can be responsible for dequeuing the packets stored in the sub-queues, i.e., scheduling the order in which the packets are to be dequeued from the multiple sub-queues.

### Schedulers and Queue Structures

——Round Robin Schedulers: Some network schedulers may be based on the “round robin” principle, in which an equal amount of resource is given in turn and in sequence to each traffic class or traffic flow that is congesting the queue structure. A basic Round Robin (RR) scheduler can process in turn one packet of each non-empty sub-queue. The basic RR scheduler can achieve per-packet fairness, where each traffic flow may have an equal number of packets forwarded over time. In a Weighted Round Robin (WRR) scheduler, different weights may be configured for the sub-queues. The WRR scheduler can process packets of the sub-queues in proportion to those weights and can also use the weights to implement some types of QoS policies.

Deficit Round Robin (DRR) is a round robin scheduler based on a “quantum,” which can represent a number of bytes and is a static, pre-configured value. The DRR scheduler can allocate in turn a quantum of bytes to each sub-queue and subsequently process from the sub-queue as many packets as allowed based on the quantum. Any unused portion of the quantum can be saved in the sub-queue for subsequent processing. This modification of Round Robin can achieve per-byte fairness (i.e., bandwidth fairness). However, the granularity of the fairness may be limited by the size of the quantum.

Deficit Weighted Round Robin (DWRR) is a version of the DRR scheduler and can use weights for the sub-queues. When computing the number of bytes, the quantum can be multiplied by the weight of the sub-queue.

——Fair Queuing Schedulers: Fair Queuing (FQ) schedulers aim to achieve the best possible latency fairness and bandwidth fairness with the smallest granularity of fairness. FQ schedulers can emulate the result of a bit-by-bit round robin, while preserving packet boundaries. Compared to the RR schedulers, FQ schedulers can achieve bandwidth fairness. Compared specifically to DRR schedulers, FQ schedulers can implement fairness using a much smaller granularity.

Many versions of FQ schedulers can be modified into Weighted Fair Queuing (WFQ) schedulers by configuring weights for the sub-queues, where the weights can be used to implement some types of QoS policies. A sub-queue weight can be expressed in bytes per second.

Self-Clocked Fair Queuing (SCFQ) is a Fair Queuing scheduler that uses the notion of virtual time based on the sub-queues rather than the overall queue structure. The virtual time can effectively be related to the byte count progress in a sub-queue. When a packet arrives at the SCFQ queue structure, the system can assign the packet a finish time as its associated packet virtual time. If the sub-queue is empty, the system can set the finish time of the packet to the global virtual time plus the size of the packet in bytes divided by the weight of the sub-queue. If the sub-queue is not empty, the system can set the finish time of the packet as the finish time of the previous packet on that sub-queue plus the size of the packet in bytes divided by the weight of the sub-queue.

To forward a packet, the SCFQ scheduler can scan the sub-queues and select the packet with the lowest finish time (i.e., based on the associated packet virtual time). After forwarding that packet, the SCFQ scheduler can update the global virtual time with the finish time of that forwarded packet.

Start-time Fair Queuing (STFQ) may provide an improvement over SCFQ and can be considered one of the most efficient and fair schedulers. The main difference between STFQ and SCFQ is that STFQ uses the start time of packets instead of the finish time. In STFQ, the packets can be tagged with their start time and scheduled based on their start time. The global virtual time can also be updated using the start time of the packet.

——Queue Structures: The complexity of a multi-queue structure can be a challenge. Multiple sub-queues need to be implemented, which can increase the complexity of implementation and the usage of resources.

Push-In First-Out (PIFO) is a queue structure that can implement fairness and complex QoS policies with a single queue. Upon arrival at a PIFO queue structure, a packet can be classified and associated with a virtual sub-queue. A virtual sub-queue can be a memory region which stores the configuration and metadata related to a class, classification, or category associated with the packet. For example, a virtual sub-queue can store the number of packets of a related packet class (e.g., related to a specific type of traffic) that are currently stored in the PIFO (or other) queue structure. An example of using virtual sub-queues with a PIFO is described below in relation to FIG. 6. The virtual sub-queue can compute a rank for the packet, and the packet can be inserted in the PIFO queue based on its rank, such that packets are in rank order in the queue.

SCFQ and STFQ can be implemented over PIFO. The virtual sub-queue only needs to keep track of the latest finish-time or start-time of the virtual sub-queue. As described below in relation to FIG. 6, PIFO can be viewed as a virtual multi-queue structure, because although it only has a single queue, PIFO can have many of the properties of a multi-queue structure, such as managing traffic in virtual sub-queues.

One challenge with the PIFO queue structure is implementing the insertion of packets in the queue in rank order. Many queue structures do not allow this type of insertion, and for queue structures that do allow it, the computational expense can increase along with the length of the queue.

Admission-In First-Out (AIFO) is a queue structure that simplifies PIFO by removing packet ordering and only using a FIFO queue. Instead, AIFO can implement an admission process to drop packets that would have been tail-dropped in the equivalent PIFO or multi-queue structure. By selectively dropping packets for each virtual sub-queue, AIFO can approximate PIFO.

An approximation of STFQ can be implemented over AIFO. Because AIFO cannot reorder packets, AIFO with STFQ can only provide approximate fairness at coarser scale. As described below in relation to FIG. 6, AIFO can be viewed as a virtual multi-queue structure, because traffic is managed in virtual sub-queues.

### Buffer Management

As described above, most queue structures have a limited amount of the resource of packet buffers, and thus careful management of the buffer resource may be required. Packet buffers can place pressure on the memory subsystem of network devices. Because a network device has a finite amount of memory, any memory used by the packet buffers for one or more queues or sub-queues of a queue structure can represent memory that cannot be used for something else. Some high-speed networking devices may need fast memory for buffers. Given the cost of memory, a benefit can be seen in reducing memory usage to lower the overall cost of the network device. For software devices, a larger number of buffers can exceed the CPU cache size, which can result in cache trashing and lower overall performance. Furthermore, large queues may consume a higher amount of compute resources, as those queues and buffers require management.

As a result of these limitations, one goal of buffer management can be to reduce queue length. However, traffic performance may be impacted when queues are too short. Network traffic can be bursty, which can require queues to store the burst of packets. If a queue is too short (i.e., its capacity is too small), the queue cannot accommodate regular bursts of traffic. One issue with a too-small queue is therefore the dropping of the later part of the traffic bursts. Dropping too many packets can reduce network performance, as that traffic needs to be retransmitted. Another issue with a too-small queue is that the queue may starve between bursts of packets because the queue cannot store enough packets. After processing the part of the burst that was not dropped, a period of time can exist when the queue is empty and has nothing to send, which can result in decreasing the overall performance.

A too-small queue along with dropping too many packets may also prevent many network transport protocols (such as Transport Control Protocol (TCP)) from reaching optimal performance. Many transport protocols may have a short term variation in rate, and the queue size needs to be large enough to accommodate those variations. In many cases, excessive dropping of packets can be interpreted by the transport protocol as congestion, which can result in the sender reducing its rate. The length of the queue needed for optimal performance of a flow may depend on the transport protocol used, the round trip time (RTT) of the network path, and the rate of the flow. The aggregation of various flows creating traffic at the queue can make the optimal queue length more difficult to predict. As a result, in most cases, it can be difficult or not possible to precisely define the necessary queue length.

In some cases, the optimal queue length QL for a queue and a number of TCP Reno flows can be QL=RTT*C/sqrt (n), where: “RTT” indicates the average round trip time of flows; “C” indicates the bandwidth capacity of the queue; and “n” indicates the number of flows in the queue. However, both RTT and n can be properties of the traffic and thus may be difficult to measure in a network device. In addition, in a sub-queue, the capacity of the overall queue structure may be shared among all the sub-queues, so the capacity of a single sub-queue may depend upon the other sub-queues. For other TCP congestion control (e.g., TCP Cubic and TCP Bottleneck Bandwidth and Round-trip propagation time (BBR)), the formula may be different. There is currently no formulation for a mix of TCP congestion controls. Real-time traffic may often use User Datagram Protocol (UDP) instead of TCP and would thus have different queueing requirements.

Buffer Management is a technique which can determine an amount or number of buffers to dedicate to a specific queue. Buffer Management can be complex for even single queues. The amount of buffers needed in a single queue may depend on many factors, including the amount of congestion, the burstiness of the traffic, and the behavior of the transport protocols of each flow. These factors may be difficult to measure, and their interplay may be complex. Thus, in many cases, queues can be configured with a static conservative allocation. This allocation could be a fixed number of packets, a fixed number of bytes, or a fixed queuing delay.

In multi-queue structures, Buffer Management can be even more complex, because the buffers allocated to the queue structure need to be shared amongst the sub-queues. A simple strategy can be to only manage buffers globally, but a sub-queue could consume all the buffers and starve the other sub-queues. A static split of the buffers amongst sub-queues can be very inefficient, as in many cases, the traffic can be concentrated in a few sub-queues, while most sub-queues are unused or only lightly used. Using a static split can result in many buffers being allocated to queues where they are unused.

The number of active flows at a queue structure can vary by multiple orders of magnitude (typically 1 to 1,000), and the traffic patterns can be unpredictable. As a result, a conservative or static allocation of buffers to the sub-queues can be both very inefficient and costly.

Dynamic Buffer Management (DBM) is a technique or system which can dynamically allocate buffers to the sub-queues of a multi-queue system. In most DBM techniques, the goal can be to maximize the overall buffer usage and minimize the sub-queue starvation. A good DBM system can reduce the amount of buffers used by a queue structure with minimal impact on performance.

DBM can also be beneficial for virtual multi-queue structures like PIFO and AIFO. PIFO and AIFO queue structures may have the same issues as the multi-queue structures: buffers need to be allocated to the virtual sub-queues in order to avoid one virtual sub-queue entirely filling the single queue and starving the other virtual sub-queues. DBM can be independent or unrelated to the scheduler used for the queue, and therefore can usually be combined with any scheduler.

Active Buffer Management (ABM) is a form of DBM that uses techniques derived from Active Queue Management (AQM). ABM can use a complex formula to compute a maximum length for each sub-queue based on the drain rate of the sub-queue, its current length, the number of congested sub-queues, and a configuration factor. Previous DBMs may have only accounted for the number of congested sub-queues. ABM can extend previous DBMs by also accounting for the rate of the sub-queues.

The maximum sub-queue size (sQSi) can be represented as:

$$sQSi = alphap / np * ( QS - QL ) ⋆ uip / b \qquad Equation ( 1 )$$

where:
“alphap” indicates an allocation factor for priority p,
“np” indicates number of congested queues for priority p,
“QS” indicates a queue size which is the total amount of buffer allocated,
“QL” indicates a queue length which is the amount of buffer used,
“uip” indicates the drain rate of sub-queue i, and
“b” indicates the maximum rate of the queue.

Equation (1) can be designed to maximize burst absorption in the sub-queues. The allocation can be proportional to the drain rate of the sub-queue, so the sub-queue using more bandwidth may be allocated more buffers. As the overall buffer capacity decreases (i.e., QS-QL), the sub-queue allocations can be correspondingly decreased.

### Active Queue Management; Congestion Management

——Active Queue Management (AQM): Buffer Management can define the maximum number of packets in a queue. If a packet arrives at a queue or sub-queue that is already full, usually the only option is to drop the packet (e.g., discard the packet). This behavior is called “tail-drop” and can be a simple way to signal congestion to the traffic originators. Most transport protocols (e.g., TCP) can monitor packet drops and subsequently reduce their sending rate when detecting packet losses.

One limitation of tail-drop is that it signals congestion only when the queue is full. Active queue management (AQM) techniques can be used to avoid the queue becoming full, by randomly dropping packets based on the congestion level. AQM can generate a packet drop before the queue becomes full, which can make the traffic sender reduce their rate, and subsequently reduce congestion before the queue becomes full. In addition, AQM can reduce the average utilization of the queue, which can be beneficial as it can result in a reduction in both buffer usage and queuing latency.

——Explicit Congestion Notification (ECN): Packet drops may be undesirable because they need to be retransmitted. Explicit Congestion Notification (ECN) can add a mechanism in the TCP protocol to carry a congestion signal from the queue to the TCP sender without the need to drop packets.

ECN can generally be used with an AQM. When the AQM randomly marks a packet, instead of dropping the packet, the AQM can set the special value ECN-Congestion Experienced (CE) in the header of the TCP packet. The TCP receiver can forward this congestion signal to the TCP sender, and the TCP sender can use this signal to reduce its sending rate. Other transport protocols can use mechanisms similar to ECN.

——Random Early Detection (RED): RED is an AQM which is based on the queue length. RED can define a probability of drop which is based on the queue occupancy. The queue occupancy can be measured in number of packets or number of bytes. RED can define two queue length thresholds: T1 and T2. When the current queue length is smaller than T1, no packet drops may occur. When the current queue length is greater than T2 and not full, the probability of packet drop can be P. When the current queue length is between T1 and T2, the probability can be between 0 and P, with the probability increasing linearly with greater queue length.

——Codel AQM: Codel AQM is an AQM based on packet delay instead of queue size. Codel AQM can measure the queuing delay of each packet. When a packet arrives at the queue, the packet can be timestamped in its metadata with the current time. When the packet is dequeued, the time difference between the timestamp and the current time can indicate the queuing delay. When the queuing delay of a packet exceeds a threshold, Codel AQM can mark some packets for congestion, either by dropping them or setting the ECN-CE value in the packet header.

——Multi-Queue with AQM and ECN: Multi-queue structures with schedulers can only enforce the ordering of packets being processed by the queue structure. How congestion is managed is not specified. Most multi-queue structures can implement a simple tail-drop policy. The number of packets in the overall queue structure can be limited by the Buffer Management. When the limit is reached, packets may be dropped. Multi-queue structures with DBM can implement a tail-drop policy independently for each sub-queue.

Multi-queue structures can thus benefit from AQM and ECN, to decrease sub-queue lengths and increase TCP performance. In general, the AQM process can be performed independently for each sub-queue, as each sub-queue has different conditions. One implementation is FQ-Codel, which combines a Deficit Round Robin with the Codel AQM.

——Flow Control and Other Congestion Management Techniques: As discussed herein, network queues must manage congestion due to the finite amount or number of buffers. Multiple strategies may be used to manage congestion, e.g., Buffer Management, Active Queue Management, and flow control. Flow control is a strict version of congestion management and uses explicit signals or dedicated packets going in the reverse direction of the traffic. In general, the goal of flow control is to entirely avoid packet losses.

TCP can support two congestion signals: dropping packets; and setting the ECN-CE value in the header. Both of these congestion signals can use Buffer Management and Active Queue Management. Other network technologies can implement other techniques for congestion management. For example, flow control can be used in networks that have a poor tolerance to packet losses.

IEEE Ethernet (802.3) has been defining various flow control features, which can be used for congestion management of the queues.

The “pause” frame (original 802.3 Ethernet standard) can stop an adjacent Ethernet device from sending data for a short amount of time. Through judicious sending of pause frames, the level of congestion and queue length can be managed. Priority flow control (PFC) (part of the 802.1Qbb) can be defined and the pause frames made specific to a priority, which can enable performance of congestion control separately for each class of service. Quantized Congestion Notification (QCN) (part of 802.1Qau) can be another congestion management for Ethernet. The QCN standard can define an AQM derived from the Proportional-Integral (PI) model, and the feedback can be a 6-bit numerical value computed from the sub-queue size and the sub-queue size increase. Source Flow Control (SFC) (part of 802.1Qdw) can define a much improved congestion control framework for Ethernet, where pause frames can be sent per flow and directly to the Ethernet node which is the source of the traffic.

### Virtual-Time Rate (VTR) Mechanism/Technique

Aspects of the instant application describe a “Virtual-Time Rate” technique or mechanism to handle Dynamic Buffer Management for a multi-queue system. The Virtual-Time-Rate technique (also referred to simply as “VTR”) can measure the rate of the progress of virtual time of a fair scheduler to infer the fair rate of each sub-queue, and subsequently use the measured virtual time rate to dynamically compute a maximum queue size for the sub-queues. VTR can also be used to compute a queue delay that can be used in an AQM and flow control.

VTR can account for both the number of active sub-queues and the rate of progress of those sub-queues, while being simpler and fairer than ABM. VTR can also be used to compute thresholds in terms of number of packets, number of bytes, or queuing delay, which can offer flexibility in configuration. VTR can reuse the underpinning of STFQ, a popular scheduler, and thus can add little additional complexity for queue structures which are already using STFQ.

As described herein and in FIGS. 3-6, VTR can be used to implement Dynamic Buffer Management as well as Active Queue Management or flow control. VTR can be compatible with any multi-queue structure, including virtual multi-queue structures such as PIFO or AIFO. VTR can be easy to configure, compatible with most schedulers, and provide a simple, fair, and efficient method of congestion management and resource allocation.

### ——How to Determine the Current Width of a Queue Structure

A fundamental factor that Dynamic Buffer Management attempts to determine is how many sub-queues need buffers, such that the pool of buffers can be shared fairly amongst those sub-queues which need buffers instead of those sub-queues that do not need buffers. The number of sub-queues needing buffers can be referred to as the “width” of the queuing structure. If ‘n’ is the width of the queue structure and there are ‘QS’ buffers for the queue structure, then each of the ‘n’ queues can be allocated ‘QS/n’ buffers.

A simple technique for measuring queue width is to count the number of active sub-queues in the queue structure. One challenge of this technique is that not all sub-queues have the same scheduling rate. The scheduler may schedule some sub-queues more frequently based on their weight and traffic demand. Sub-queues that are used more should ideally receive a greater number of allocated buffers than sub-queues that are used less. As discussed above, Active Buffer Management (ABM) can address this issue, such that the allocation can be proportional to the scheduled rate of the sub-queue. Another challenge of this technique is that there exists no formal or clear definition of an “active” queue. Many DBM systems, such as ABM, instead count the number of congested queues.

A first issue with counting the number of congested queues is that measuring the number of congested queues can be inconsistent and problematic. Some delay-based transport protocols may operate congested queues with low buffer occupancy. On the other hand, some uncongested traffic can be very bursty, so a simple queue length threshold may not work to determine whether a queue is congested. Furthermore, measuring the rate of the queue can also be inconsistent and problematic, because congestion can indicate the difference between the expected rate and the actual rate, and the expected rate may be unknown at the queue. Thus, properly and accurately measuring the number of congested queues may require some longer term queue occupancy statistics.

A second issue with counting the number of congested queues is that uncongested queues may also consume some buffers. Those buffers can add up, especially for large number of sub-queues. This can create a problem when there are only a very small overall number of buffers, as every buffer counts. Thus, the buffer usage of non-congested queues must also be accounted for, but only proportionally to what they are using. In other words, buffer usage by non-congested queues should not count in the same manner as buffer usage by fully congested queues.

Thus, due to these challenges and issues (i.e., queue width not clearly defined, all sub-queues do not have the same needs, etc.), the queue width may be difficult to measure and may be an imperfect abstraction.

### Virtual-Time Rate (VTR) and Fair Share Ratio

The described aspects of the Virtual-Time Rate (VTR) mechanism can be based on a hypothetical fair scheduler which uses virtual time, such as the SCFQ or STFQ schedulers. VTR can define “Virtual-Time.” A sub-queue can include packets which have been enqueued into the sub-queue and are associated with a respective packet virtual time. The packet virtual time can indicate a relative order of processing based on a configured weight for a sub-queue into which the packet is to be placed and a size of the packet or another packet in the sub-queue. That is, the respective packet virtual time can be a value based on a virtual time of the sub-queue, which can be incremented based on a size of packets enqueued into the sub-queue and a weight of the sub-queue. A property of Virtual-Time is that each sub-queue can have an associated “tail-sub-time” which increases in proportion to the number or size of the packets processed by the sub-queue, and the tail-sub-time may be used to compute the virtual time of packets. The global virtual time can be related to the virtual time of the packets dequeued from the queue structure.

If the queue structure implements a fair scheduler with virtual time (e.g., SCFQ and STFQ), then Virtual-Time can usually be the virtual time of that scheduler. If the queue structure does not implement a suitable scheduler, then VTR must implement a virtual STFQ scheduler, which does not schedule packets but only computes the Virtual-Time. If a weighted fair scheduler is used (e.g., WRR), the virtual STFQ scheduler should include sub-queue weights that match the weights of the actual scheduler.

VTR can also define “Aggregate-Time.” Aggregate-Time can indicate the number or size of all packets from all sub-queues forwarded by the queue structure, and not just the number or size of packets from a single sub-queue forwarded by the queue structure. Most queue structures may already use packet and byte counters which track forwarded packets. VTR can be based on such counters.

Assume that VTR uses an STFQ scheduler (real or virtual) and that all sub-queues have the same weight. In each sub-queue, the start-time can increase consistently, and the virtual time can advance by the size of the packet added to the sub-queue. On the other hand, the virtual time may often not increase consistently, as it depends upon which packet is scheduled.

If there is only one active sub-queue, Virtual-Time can increase at the rate of only that sub-queue, i.e., Virtual-Time can advance based on the size of the packets dequeued from that one active sub-queue. In the case of only one active sub-queue, Aggregate-Time indicates the number or size of packets from all sub-queues (in this case, the only one active sub-queue) forwarded by the queue structure, and Aggregate-Time can also advance based only on the size of the packets dequeued from that one active sub-queue. Thus, Virtual-Time can advance at the same rate as Aggregate-Time.

If there are multiple active sub-queues, the scheduler can always select the oldest packet (i.e., the packet with the lowest or oldest packet virtual time), so Virtual-Time can advance at the rate of the slowest sub-queue and advance by the sum of the packets dequeued from only the slowest sub-queue. Between each packet of that slowest sub-queue, the scheduler may forward packets from other sub-queues, so the overall advance of the Virtual-Time can be less than the advance of the Aggregate-Time. In addition, an increased number of active sub-queues can result in a reduced advancing of the Virtual-Time when compared to the Aggregate-Time.

The difference of rate between the Virtual-Time and the Aggregate-Time can be related to the width of the queues or sub-queue, because the width of the queue depends on the size of the packets, and the rates of progress indicated by Virtual-Time and Aggregate-Time can be based on the size of the packets in the queues or sub-queues. However, the relation between the queue width and the rate difference can be complex, as it may depend upon the level of activeness of each sub-queue.

In a sub-queue, the rate of the virtual time of packets dequeued from that sub-queue can indicate its progress (e.g., over a predefined time period). By computing the ratio of the sub-queue rate (i.e., the Virtual-Time rate or the progress of packets dequeued from the slowest sub-queue) with the aggregate rate of the overall queue structure (e.g., the Aggregate-Time rate or the progress of all packets dequeued from all the sub-queues of the queue structure), VTR can simply determine the current share of the sub-queue in the overall queue structure.

For example, if a sub-queue is advancing at 1/10th the rate of the overall queue structure (i.e., the number or size of packets being dequeued from the sub-queue is 1/10th the number or size of packets being dequeued from the overall queue structure), then that sub-queue is using 10% of the bandwidth, and on average, that sub-queue can occupy (or be allocated) 10% of the buffers of the overall queue structure.

As described herein, Virtual-Time can indicate the progress of the slowest sub-queue (e.g., the sub-queue with the lowest sub-queue virtual time). The scheduler used by VTR can implement fair processing of the sub-queues, such that all congested sub-queues should be progressing at the rate of the slowest sub-queue. As a result, the rate of progress of Virtual-Time can be the fair rate for all the sub-queues. By computing the ratio of that fair rate (Virtual-Time rate) to the aggregate rate of the overall queue structure (Aggregate-Time rate), e.g., fair rate/aggregate rate), VTR can simply determine a “Fair Share Ratio” for the sub-queues.

In the described aspects, the system can assign such a Fair Share Ratio to all the sub-queues. All the congested sub-queues should use that Fair Share Ratio, while the uncongested sub-queues should use less than the Fair Share Ratio (so it does not matter if those uncongested sub-queues are assigned a greater portion of the Fair Share Ratio). If the number of congested queues changes, the Virtual-Time rate will change, and the Fair Share Ratio will change accordingly. Furthermore, the Virtual-Time rate can depend on both the congested and the uncongested sub-queues, such that the Fair Share Ratio can properly reflect the impact of the uncongested sub-queues.

One advantage of computing a Fair Share Ratio is that the Fair Share Ratio can be computed globally and need not be computed individually for each sub-queue. A Fair Share Ratio based on the Virtual-Time Rate can be computed without having to compute or measure the number of congested queues and the individual queue rates, and, consequently, can be simpler than previous methods such as ABM.

The above description with the mentioned assumptions illustrates VTR for STFQ when all the sub-queues have the same weight. The above description can extend naturally to SCFQ and STFQ with weights. The virtual time of a sub-queue can represent its progress divided by its weight. Thus, the Virtual-Time rate can be the fair rate for a hypothetical sub-queue of weight one. The fair rate of each sub-queue can be the Virtual-Time rate multiplied by the weight of the sub-queue. Similarly, the fair share of a queue can be the Fair Share Ratio multiplied by the weight of the sub-queue.

FIG. 3 illustrates an environment 300 which facilitates managing queues based on a virtual time rate and a scaled metric, in accordance with an aspect of the present application. Environment 300 can include a classifier 304, a plurality of sub-queues 310, 320, 330, and 340 (i.e., the queue structure), and hardware/software components, elements, modules, or units which can perform queue management functionality. Classifier 304, sub-queues 310-340, and the queue management functionality described herein (e.g., related to operations 350, 352, 356, 358, 359, 362, 363, and 364) as well as a scheduler (not depicted in FIG. 3 but similar to scheduler 250 of FIG. 2) which can perform at least operation 358 can be implemented in a system comprising hardware or software or a combination of hardware and software. Sub-queues 310, 320, 330, and 340 can be FIFO queues, can each be associated with a particular class, and can include zero or more packets. For example: sub-queue_1 310 can include at least packets 312 and 314; sub-queue_2 320 can include at least a packet 322; sub-queue_3 330 can include at least packets 332, 334, 336, and 338; and sub-queue_4 340 can include at least packets 342, 344, and 346. Environment 300 may include a fewer or greater number of sub-queues than as illustrated in FIG. 3. Queue management functionality can include: performing operations on a packet (e.g., a compare metric 350 operation, a compute packet virtual time 356 operation, a drop or modify 352 operation, and a read packet virtual time 358 operation); updating or calculating information associated with the queue structure (e.g., a measure virtual time rate 362 operation, a compute aggregate rate 359 operation, a compute fair share ratio 363 operation, and a scale metric 364 operation); and storing information associated with the queue structure (e.g., a global virtual time 360, an amount of resource 354, a sub-queue metric 394, and a scaled metric 396). Global virtual time 360 can correspond to a current global virtual time for the queue structure, while sub-queue metric 394 can correspond to a characteristic of the sub-queue length or metadata attached to it, e.g., its current packet length.

In environment 300, a packet 302 can be received by classifier 304 (depicted by an arrow 370). Classifier 304 can classify packet 302 by assigning a class to packet 302, to be enqueued at the end (i.e., the tail) of the corresponding sub-queue. Upon arrival of packet 302 at the queue structure (i.e., upon enqueuing into sub-queue_1 310 after classification, depicted by an arrow 372), the system can perform compare metric 350 operation.

The system can perform congestion management (e.g., AQM or DBM), by comparing scaled metric 396 with amount of resource 354 (indicated as an input to compare metric 350 operation by an arrow 398) to determine if the packet can be enqueued into the selected sub-queue. Scaled metric 396 may be provided based on a previous packet being dequeued from the queue structure, which triggers updating the global virtual time (stored as 360), measuring the virtual time rate (operation 362), computing the aggregate rate (operation 359), and scaling the metric (operation 364). Scaled metric 396 can effectively be the sub-queue metric 394 rescaled by the inverse of the Fair Share Ratio (computed in operation 363 and indicated as an input to scale metric 364 by an arrow 392). The Fair Share Ratio can indicate the ratio of the resource to be allocated to each queue of weight 1.

If the comparison of scaled metric 396 to amount of resource 354 determines that the packet can be enqueued into the selected sub-queue (decision 350), the system can compute the packet virtual time (depicted by an arrow 378 to operation 356), such as a packet virtual time based on the implemented scheduler (e.g., using the finish time if SCFQ and using the start time if STFQ). If the sub-queue is empty, the packet virtual time can be based on the global virtual time (e.g., virtual time 360, obtained as depicted by an arrow 388). If the sub-queue is not empty, the packet virtual time can be based on the packet virtual time associated with the previous packet (e.g., packet 312) on that sub-queue plus its size in bytes divided by the weight of the sub-queue. The packet virtual time can indicate a relative order of processing of the packet (e.g., in a number representing a size of packets, such as bytes) upon being enqueued into a queue or sub-queue of the queue structure. The system can enqueue the packet into the selected sub-queue (as indicated by an arrow 380).

If the comparison of scaled metric 396 to amount of resource 354 determines that the packet cannot be enqueued into the selected sub-queue (decision 350), the system can drop or modify the packet (depicted by an arrow 374 to operation 352). If the system determines to modify the packet (e.g., to mark the ECN-CE value or other flow congestion value), the system can subsequently compute the packet virtual time (depicted by an arrow 376 to operation 356).

Upon the scheduler dequeuing a packet (depicted by an arrow 382), the system can read the packet virtual time (operation 358), update global virtual time 360 (depicted by an arrow 386), and forward the packet (depicted by an arrow 384 to a packet 306). The system can use global virtual time 360 to measure the rate of progress of the virtual times of packets processed or dequeued by the scheduler (depicted by an arrow 390 to operation 362), from which the “fair rate” of the queues may be inferred, and which can correspond to the rate of progress of packets processed by the slowest sub-queue. Measure virtual time rate 362 operation can compute the “global virtual time rate” by measuring the global virtual time over a predefined time period. Furthermore, in some instances, the system can compute a rate comprising a progress of all packets dequeued by the scheduler over the predefined time period from all the sub-queues (referred to as the “aggregate rate”), e.g., by performing compute aggregate rate 359 operation based on dequeued packet 306 (depicted by an arrow 385 to operation 359). Compute fair share ratio 363 operation can measure a ratio of the global virtual time rate (the fair rate obtained from operation 362 as depicted by an arrow 391) to the aggregate rate (obtained from operation 359 as depicted by an arrow 387). This ratio of the fair rate/aggregate rate can be referred to as the Fair Share Ratio. Scale metric 364 operation can thus scale sub-queue metric 394 based on the fair rate and the aggregate rate (i.e., the Fair Share Ratio obtained from operation 363 as depicted by an arrow 392), e.g., by dividing the sub-queue metric by the ratio of fair rate/aggregate rate, which can be represented as scaled metric 396 (e.g., sub-queue metric/fair rate*aggregate rate). As described above, compare metric 350 can use scaled metric 396 against amount of resource 354 to determine how much of the resource should be allocated to the sub-queues, which can determine whether a subsequent arriving packet may be enqueued into a selected queue.

### Virtual-Time Rate for Dynamic Buffer Management

FIG. 4 illustrates an environment 400 which facilitates managing queues based on a virtual time rate for buffer management, in accordance with an aspect of the present application. Environment 400 can include a classifier 404, a plurality of sub-queues 410, 420, 430, and 440 (i.e., the queue structure), and hardware/software components, elements, modules, or units which can perform queue management functionality. Classifier 404, sub-queues 410-440, and the queue management functionality described herein (e.g., related to operations 450, 452, 456, 458, 459, 462, 463, and 464) as well as a scheduler (not depicted in FIG. 4 but similar to scheduler 250 of FIG. 2) which can perform at least operation 458 can be implemented in a system comprising hardware or software or a combination of hardware and software. Sub-queues 410, 420, 430, and 440 can be FIFO queues, can each be associated with a particular class, and can include zero or more packets. For example: sub-queue_1 410 can include at least packets 412 and 414; sub-queue_2 420 can include at least a packet 422; sub-queue_3 430 can include at least packets 432, 434, 436, and 438; and sub-queue_4 440 can include at least packets 442, 444, and 446. Environment 400 may include a fewer or greater number of sub-queues than as illustrated in FIG. 4. Queue management functionality can include: performing operations on a packet (e.g., a compare length 450 operation, a compute packet virtual time 456 operation, a drop packet 452 operation, and a read packet virtual time 458 operation); updating or calculating information associated with the queue structure (e.g., a measure virtual time rate 462 operation, a compute aggregate rate 459 operation, a compute fair share ratio 463 operation, and a scale buffers 464 operation); and storing information associated with the queue structure (e.g., a global virtual time 460, a number of buffers 454, a sub-queue length 494, and a scaled buffers 496). Global virtual time 460 can correspond to a current global virtual time for the queue structure, while sub-queue length 494 can correspond to a length of a sub-queue selected for enqueuing a packet.

In environment 400, a packet 402 can be received by classifier 404 (depicted by an arrow 470). Classifier 404 can classify packet 402 by assigning a class to packet 402, to be enqueued at the end (i.e., the tail) of the corresponding sub-queue. Upon arrival of packet 402 at the queue structure (i.e., upon enqueuing into sub-queue_1 410 after classification, depicted by an arrow 472), the system can perform compare length 450 operation. The system can execute a tail-drop policy, by comparing sub-queue length 494 with scaled buffers 496 (e.g., the amount of allocated buffer for the sub-queue). Scaled buffers 496 can be provided based on a previous packet being dequeued, which triggers updating the global virtual time (stored as 460), measuring the virtual time rate (operation 462), computing the aggregate rate (operation 459), and scaling the buffers (operation 464). Scaled buffers 496 can effectively be the amount or number of buffers 454 rescaled by the Fair Share Ratio (computed in operation 463 and indicated as an input to scale buffers 464 by an arrow 492). Scaled buffers 496 can indicate the fair amount of resource to be allocated to each queue of weight 1.

Thus, the system can determine whether sub-queue length 494 is less than scaled buffers 496 (decision 450). If sub-queue length 494 is less than scaled buffers 496 (decision 450) (i.e., sufficient space exists in the sub-queue for the packet to be enqueued into the selected sub-queue), the system can compute the packet virtual time (depicted by an arrow 478 to operation 456) (as described above in relation to operation 356 of FIG. 3) and enqueue the packet into the selected sub-queue (as depicted by an arrow 480). If sub-queue length 494 is greater than scaled metric 496 (decision 450) (i.e., insufficient space exists in the sub-queue for the packet to be enqueued), the system can drop the packet (operation 452). The scaled metric can be the sub-queue length 494 divided by the Fair Share Ratio (obtained from operation 463 as depicted by arrow 492). As a result, comparing sub-queue length 494 to scaled buffers 496 can be identical to comparing the scaled metric to the amount of buffers (see Equations 7 and 8).

Upon the scheduler dequeuing a packet (depicted by an arrow 482), the system can read the packet virtual time (operation 458), update global virtual time 460 (depicted by an arrow 486), and forward the packet (depicted by an arrow 484 to a packet 406). The system can use global virtual time 460 to measure the rate of progress of the virtual times of packets processed or dequeued by the scheduler (depicted by an arrow 490 to operation 462), from which the “fair rate” of the queues may be inferred, and which can be roughly the rate of progress of packets processed by the slowest sub-queue. Measure virtual time rate 462 operation can compute the “global virtual time rate” by measuring the global virtual time over a predefined time period. The system can perform compute aggregate rate 459 operation to obtain the aggregate rate based on dequeued packet 406 (depicted by an arrow 485 to operation 459). Compute fair share ratio 463 operation can measure a ratio of the fair rate (obtained from operation 462 as depicted by an arrow 491) to the aggregate rate (obtained from operation 459 as depicted by an arrow 487), i.e., the Fair Share Ratio. Furthermore, the system can determine the length of the selected sub-queue (illustrated as sub-queue length 494). Scale buffers 464 operation can subsequently scale the number of buffers 454 (indicated as an input to scale buffers 464 by an arrow 498) based on the Fair Share Ratio (obtained from operation 463 as depicted by an arrow 492), e.g., by multiplying the number of buffers by weight*virtual time rate/aggregate rate, which can be represented as scaled buffers 496 or a scaled metric 496 (e.g., number of buffers*weight*virtual time rate/aggregate rate). Compare length 450 operation can compare sub-queue length 494 against scaled metric 496 to determine whether sufficient space exists for a packet to be enqueued into sub-queue_1 410, which can result in either dropping the packet (depicted by an arrow 474 to operation 452) or computing the packet virtual time (depicted by an arrow 478 to operation 456) prior to enqueuing, as described above.

The described aspects of Virtual-Time Rate can be used for Dynamic Buffer Management. VTR can compute the Fair Share Ratio, and each sub-queue may be simply allocated a number of buffers equal to the Fair Share Ratio of the buffer pool multiplied by the sub-queue weight.

The maximum sub-queue size can be represented by:

$$sQSi = FS * QS * w = VTr / ATr * QS * w \qquad Equation ( 2 )$$

where:
“QS” indicates a queue size which is the total amount of buffer allocated,
“w” indicates the sub-queue weight,
“FS” indicates the Fair Share Ratio computed by the Virtual-Time rate,
“VTr” indicates the Virtual-Time rate and is based on the global virtual time (of SCFQ or STFQ) and is indicative of the progress of packets processed in the slowest sub-queue, and
“ATr” indicates the Aggregate-Time rate and is the aggregate progress of packets processed by the queue structure.

Equation (2) can be simplified further. Assume that the rates are measured over an amount of real time ‘td’ (e.g., a predefined time period), and during this time interval td, the Virtual-Time has progressed by the amount ‘VTd’, and the Aggregate-Time by amount ‘ATd.’ With SCFQ and STFQ, both ‘VTd’ and ‘ATd’ can be expressed in an amount of bytes.

As a result:

$$VTr = VTd / td \qquad Equation ( 3 )$$

$$ATr = ATd / td \qquad Equation ( 4 )$$

$$sQSi = VTd / ATd * QS * w \qquad Equation ( 5 )$$

where:
“VTd” indicates the Virtual-Time difference across time td,
“ATd” indicates the Aggregate-Time difference across time td, and
“td” indicates the time duration for measurement of VTd and ATd.

Equation (5) can work both for packet allocation or byte allocation, i.e., QS can be a number of packets or a number of bytes. The quantity VTd/ATd can be a byte ratio or packet ratio. This quantity can still measure the rate of progress of the virtual time, which rate can be measured in byte units or packet units instead of time units. In other words, sQSi can be computed from the rate of the virtual time VTd/ATd.

As described herein, VTR can be used for Dynamic Buffer Management of PIFO and AIFO queues. The same equations can be used to compute the size of the virtual sub-queues for PIFO and AIFO queues. The limit on the size of the virtual sub-queues can correspondingly limit the number of packets in the single PIFO or AIFO queue, and the portion of the queue used by each virtual sub-queue can be roughly equal to the Fair Share Ratio.

VTR can also be used for Dynamic Buffer Management of priority queues, where different sub-queues have different priorities in the scheduler. Each such sub-queue can be given an appropriate weight for the Virtual-Time rate, in order to bias buffer allocation towards the higher priority queues.

### Tail-Drop Using Scaled Sub-Queue Metric

In the described aspects of VTR for Dynamic Buffer Management, the system can compute a maximum sub-queue size. A simple tail-drop policy can ensure that the sub-queue does not exceed its dynamic allocation:

$$tail - drop = sQLi > sQSi tail - drop = sQLi > VTd / ATd * QS * w \qquad Equation ( 6 )$$

where:
“sQSi” indicates the maximum sub-queue size, and
“SQLi” indicates the current sub-queue length.

The concept of Fair Share can be converted as a scaled metric. If a metric of the sub-queue is measured (e.g., the current queue length of the sub-queue), the Virtual-Time rate can be used to scale it as if it was a metric for the full queue structure. The scaled metric can then be compared to an amount of resource for the whole structure (as described above in relation to 350 of FIG. 3).

The tail-drop policy can be converted by comparing the scaled sub-queue length with the number of buffers:

$$tail - drop = sQLi > VTd / ATd * QS * w \qquad Equation ( 7 )$$

$$tail - drop = sQLi * ATd / VTd / w > QS \qquad Equation ( 8 )$$

Equation (8) can be further optimized. Each time a packet is added to the sub-queue, the sub-queue virtual time can be advanced based on the packet, and in the inverse proportion to the weight of the sub-queue. Thus, the packet at the head of the queue can have a packet virtual time almost equal to the sub-queue virtual time. The sub-queue length can be inferred by the difference between the packet virtual time assigned to the packet at the tail of the queue and the current virtual time:

$$sQTi - VT \text{∼=} sQLi / w \qquad Equation ( 9 )$$

where:
“VT” indicates the Virtual-Time (current virtual time associated with the most recent packet dequeued from that sub-queue), and
“sQTi” can indicate the packet virtual time for the packet at the tail of the sub-queue, which can be based on the sub-queue virtual time.

The tail-drop policy of Equation (9) can be simplified as:

$$tail - drop = ( sQTi - VT ) * ATd / VTd > QS \qquad Equation ( 10 )$$

Equation (10) can be the same as comparing the sub-queue length to the maximum sub-queue size. One advantage of this reformulation is that the sub-queue length does not need to be explicitly tracked, and the weight of the sub-queue can be eliminated from the calculation, thus rendering the tail-drop policy simpler to implement.

One final optimization can be to eliminate the division, which can be computationally expensive:

$$tail - drop = ( sQTi - VT ) * ATd > QS * VTd \qquad Equation ( 11 )$$

——Reserving Buffers

One issue with VTR can be maximizing allocation of buffers to the congested queues. If all of the congested queues use their Fair Share of the buffers, no buffers may remain. This can create a problem when new traffic flows arrive at the queue structure, or when one of the non-congested queues may need more buffers or become congested. Specifically, VTR can reflect the past width of the queue, but the future width of the queue may be different. Furthermore, future traffic may be unpredictable, rendering it difficult or impossible to predict which sub-queue may need those buffers and when those buffers may be needed.

One solution is to reserve a number of buffers for such unpredicted future use. The maximum sub-queue size can thus be represented by:

$$sQSi = VTd / ATd * ( QS - QR ) * w \qquad Equation ( 12 )$$

where:
“QR” indicates the amount of buffer reserved.

An optimization can be to make the number of reserved buffers proportional to the number of sub-queues which are not congested. Thus, if more queues are congested, fewer reserve buffers may be needed and more buffers can be allocated to the sub-queues. This can be approximated by:

$$sQSi = VTd / ATd * ( QS - QR * ( 1 - ATd / VTd / nsqm ) * w \qquad Equation ( 13 )$$

where:
“nsqm” indicates the maximum number of sub-queues.

Equation (13) can also be reformulated as a scaled sub-queue metric:

$$tail - drop = ( sQTi - VT ) * ATd > QS * VTd - QR * ( VTd - ATd / nsqm ) \qquad Equation ( 14 )$$

### ——Measurement of Virtual-Time Rate

The described aspects of VTR include a measurement of both the Virtual-Time and the Aggregate-Time over a period of time ‘td’. These two values may be readily available, which allows the system to compute their values at two different points in time (e.g., over a predefined time period).

The value of ‘td’ can be very important and thus should be carefully selected. On one hand, if the value of ‘td’ is too large, it can take a long time to measure the Virtual-Time rate. However, the Virtual-Time rate can be a dynamic value based on the traffic conditions, and on most networks, network traffic can vary in unpredictable ways. Therefore, a larger ‘td’ may result in Dynamic Buffer Management being less reactive, and it may take a long time to adapt to new traffic, during which time the system may experience sub-optimal behavior.

On the other hand, if the value of ‘td’ is too small, measurement errors may occur, which can impact the accuracy of Dynamic Buffer Management. First, the sub-queues may be at time offsets which are not evenly distributed, so Virtual-Time may be updated at varying speeds while the scheduler progresses through the queues. The value of ‘td’ should be large enough to average a cycle across all active sub-queues. Second, packet arrival in non-congested sub-queues can be unpredictable, and the number of packets that need to be scheduled in all non-congested sub-queues can vary significantly over time. The value of ‘td’ should be large enough to average traffic patterns on the non-congested sub-queues. Third, in some implementations, the queue structure may not dequeue packets monotonically. Instead, packets may be dequeued in bursts, so the update of Virtual-Time may be jumpy. The value of ‘td’ should be large enough to average dequeuing burstiness.

One strategy used by some modern AQMs can be to perform the measurement of ‘td’ across the lifetime of a packet in the queue. When a packet is added in the queue, the current value of what needs to be measured can be saved in the packet metadata. When a packet is dequeued, the saved value can be compared to the current value. In effect, ‘td’ can be the queuing delay of the dequeued packet.

Both Virtual-Time and Aggregate-Time can be measured across the lifetime of a packet in the queue. However, when the queuing delay is very small, such measurements may include a significant amount of error.

Another strategy can be to configure ‘td’ to be a small multiple of the typical queue delay and measure Virtual-Time and Aggregate-Time at periodic ‘td’ time intervals. Periodic byte intervals can also be used.

### Most Dynamic Buffer Management and Active Queue Management

schemes can be based on some measurements, which should carefully define or configure the time granularity of those measurements. For example, ABM may need to measure the number of congested queues and the drain rate of each sub-queue. If the time averaging is too long, the system may be less dynamic, and if the time averaging is too short, the measurements may be too noisy.

### Virtual-Time Rate for Active Queue Management

FIG. 5 illustrates an environment 500 which facilitates managing queues based on a virtual time rate for active queue management (AQM), in accordance with an aspect of the present application. Environment 500 can include a classifier 504, a plurality of sub-queues 510, 520, 530, and 540 (i.e., the queue structure), and hardware/software components, elements, modules, or units which can perform queue management functionality. Classifier 504, sub-queues 510-540, and the queue management functionality described herein (e.g., related to operations 550, 552, 556, 558, 562, and 564) as well as a scheduler (not depicted in FIG. 5 but similar to scheduler 250 of FIG. 2) which can perform at least operation 558 can be implemented in a system comprising hardware or software or a combination of hardware and software. Sub-queues 510, 520, 530, and 540 can be FIFO queues, can each be associated with a particular class, and can include zero or more packets. For example: sub-queue_1 510 can include at least packets 512 and 514; sub-queue_2 520 can include at least a packet 522; sub-queue_3 530 can include at least packets 532, 534, 536, and 538; and sub-queue_4 540 can include at least packets 542, 544, and 546. Environment 500 may include a fewer or greater number of sub-queues than as illustrated in FIG. 5. Queue management functionality can include: performing operations on a packet (e.g., an AQM 550 operation, a compute packet virtual time 556 operation, a drop or modify 552 operation, and a read tag 558 operation); updating or calculating information associated with the queue structure (e.g., a measure rate 562 operation and a predict delay 564 operation); and storing information associated with the queue structure (e.g., a global virtual time 560, a configured delay 554, a sub-queue length 594, and a predicted delay 596). Global virtual time 560 can correspond to a current global virtual time for the queue structure, while sub-queue length 594 can correspond to a length of a sub-queue selected for enqueuing a packet.

In environment 500, a packet 502 can be received by classifier 504 (depicted by an arrow 570). Classifier 504 can classify packet 502 by assigning a class to packet 502, to be enqueued at the end (i.e., the tail) of the corresponding sub-queue. Upon arrival of packet 502 at the queue structure (i.e., upon enqueuing into sub-queue_1 510 after classification, depicted by an arrow 572), the system can perform AQM 550 operation. The system can perform congestion management (e.g., AQM) by comparing a predicted delay 596 with configured delay 554 (indicated as an input to AQM 550 operation by an arrow 598). Predicted delay 596 can be provided based on a previous packet being dequeued, which triggers updating the global virtual time (stored as 560), measuring the rate (operation 562), and predicting the delay (operation 564), as described herein.

The AQM 550 operation can use predicted delay 596 and configured delay 554 (indicated as an input to AQM 550 by an arrow 598) to compute a decision and determine what to do with the packet. In an example of a simplistic AQM, if predicted delay 596 is greater than configured delay 554, the system can drop or modify the packet (depicted by an arrow 574 to operation 552). Many AQMs can use the predicted delay 596 and the configured delay 554 to compute a probability of dropping or modifying the packet (depicted by arrow 574 to operation 552). If the system determines to modify the packet (e.g., to mark the ECN-CE value or other flow congestion value), the system can subsequently compute the packet virtual time (depicted by an arrow 576 to operation 556) with a packet virtual time based on the implemented scheduler (as described above in relation to operation 352 of FIG. 3). In some aspects, the system may pass the packet for marking the packet virtual time without modifying the packet. Based on predicted delay 596 and configured delay 554, the system can determine that the packet may be enqueued in the selected sub-queue and compute the packet virtual time upon enqueuing (depicted by an arrow 578 to operation 556). The system can enqueue the packet into the selected sub-queue (as indicated by an arrow 580).

Upon the scheduler dequeuing a packet (depicted by an arrow 582), the system can read the packet virtual time (operation 558), update the global virtual time 560 (depicted by an arrow 586), and forward the packet (depicted by an arrow 584 to a packet 506). For example, measure rate 562 operation can compute a virtual time rate based on the virtual time of packets progressing through the sub-queues and dequeued by the scheduler from all the sub-queues. Furthermore, the system can determine the length of the selected sub-queue (illustrated as sub-queue length 594). Predict delay 564 operation can thus scale sub-queue length 594 based on the measured rate (obtained from operation 562 as depicted by an arrow 592), e.g., by dividing the sub-queue length by the virtual rate and weight, which result can be represented as predicted delay 596 (also referred to as a scaled metric).

AQM 550 can use predicted delay 596 and configured delay 554 to compute a probability of dropping or modifying the packet. Based on the probability, the system can perform one of the following actions: drop the packet (depicted by an arrow 574 to operation 552); modify the packet (depicted by arrow 574 to operation 552) and compute the packet virtual time (depicted by an arrow 576 to operation 556); or compute the packet virtual time (depicted by an arrow 578 to operation 556), as described above.

Dynamic Buffer Management can compute a maximum sub-queue size, which can naturally implement a tail-drop policy (as described above in relation to FIG. 4). VTR can also be used to implement various AQMs.

Some AQMs can be based on queue length (e.g., RED). Such AQMs can be applied to sub-queues and rescaled dynamically based on the current sub-queue size sQSi. For example, RED can use a threshold (T1 or T2) based on a percentage of the current sub-queue size sQSi, e.g., T1=20%*sQSi and T2=50%*sQSi. Because sQSi can be based on the Fair Share Ratio, both T1 and T2 can be based on the Fair Share Ratio, and the final probability of marking a packet can depend upon the Fair Share Ratio. Other AQMs can use similar rescaling.

If an AQM has multiple thresholds, such as RED, using a scaled metric method (as described above in relation to FIG. 3) may be more efficient than rescaling all thresholds. The rescaled current queue length can be compared to all global thresholds appropriately.

Some AQMs can be based on queuing delay and can typically use a delay threshold (e.g., Codel AQM). One advantage of AQMs based on queuing delay can be that these AQMs can usually be applied unmodified in the context of a multi-queue structure and do not require rescaling based on the width of the queue. This is because the queuing delay can already include the impact of the number of active sub-queues, and the delay threshold can remain the same regardless of the number of active sub-queues.

Most AQMs can directly measure the queuing delay of packets, e.g., by measuring the elapsed time between when a packet arrives at the queue structure and when the packet is forwarded. However, in some cases, this direct delay measurement may be problematic. If dequeuing is bursty, the measured queuing delay may include too much error. If the traffic in the input of the queue is highly bursty, some packets may arrive after many non-congested sub-queues are filled, and those packets may need to wait longer than usual. With AIFO queues, packets may not be reordered, and thus, the queuing delay may not reflect congestion. In addition, the measurement of the queuing delay may be performed when the packet is dequeued, but some AQMs require an estimate of the queuing delay before enqueuing the packet.

In the described aspects, VTR can be used to compute a queuing delay for packets that is fairer across sub-queues. The scheduler can be expected to process the data already in a sub-queue at a rate equal to the Virtual-Time rate multiplied by the weight of the sub-queue. When a packet arrives at the queue structure, its predicted queuing delay can be computed as:

$$pQDi = sQLi / ( VTr * w ) \qquad Equation ( 15 )$$

where:
“sQLi” indicates the current sub-queue length, e.g., in bytes or packets,
“VTr” indicates the Virtual-Time rate, e.g., the virtual time of SCFQ or STFQ, and
“w” indicates the sub-queue weight.

Equation (15) can be optimized using the sub-queue virtual time, in which case the predicted queuing delay for the packet can be represented as:

$$sQTi - VT \text{∼=} sQLi / w \qquad Equation ( 16 )$$

$$pQDi = ( sQTi - VT ) / VTd * td \qquad Equation ( 17 )$$

where:
“VT” indicates the Virtual-Time,
“sQTi” can indicate the packet virtual time for the packet at the tail of the sub-queue, which can be based on the sub-queue virtual time,
“VTd” indicates the Virtual-Time difference across time td, and
“td” indicate the time duration for the measurement of VTd.

Most delay-based AQMs can compare the queuing delay of a packet to a delay threshold in order to compute a packet marking probability or to decide whether to mark the packet for congestion. Some delay-based AQMs can compute the packet marking probability by also looking at the increase or decrease in the queuing delay. The predicted delay pQDi can be used by those AQMs instead of an actual queuing delay.

The delay threshold of the AQM can represent an amount of a resource for the queue structure, expressed in time units.

Virtual-Time Rate with PIFO or AIFO

As described herein, both PIFO and AIFO queues may be viewed as virtual multi-queue structures because traffic can be managed in virtual sub-queues. As a result, the described aspects of the instant application may be implemented on a PIFO or an AIFO queue.

FIG. 6 illustrates an environment 600 which facilitates managing queues based on a virtual time rate with a Priority In First Out (PIFO) or an Admission In First Out (AIFO) queue, in accordance with an aspect of the present application. While environment 600 illustrates communications similar to the communications described above in environment 300 of FIG. 3 for the VTR mechanism with Fair Share Ratio, any of the described aspects of VTR may also be implemented on a PIFO or an AIFO queue.

Environment 600 can include a classifier 604, a plurality of virtual sub-queues (such as a virtual sub-queue_1 608 and a virtual sub-queue_N 609), a single queue 610 that may be a PIFO or FIFO queue, and hardware/software components, elements, modules, or units which can perform queue management functionality. Classifier 604, virtual sub-queues 608-609, queue 610, and the queue management functionality described herein (e.g., related to operations 650, 652, 656, 658, 659, 662, 663, and 664) as well as a scheduler (not depicted in FIG. 6 but similar to scheduler 250 of FIG. 2) which can perform at least operation 658 can be implemented in a system comprising hardware or software or a combination of hardware and software. Virtual sub-queues (such as 608) just store all the configuration and metadata related to a traffic class in the queue structure, e.g., the virtual sub-queue can store the number of packets of the related packet class currently present in queue 610. Virtual sub-queues are not real queues and do not store packets. FIFO queue 610 can be a PIFO or an AIFO queue. FIFO queue 610 may include at least packets 612, 614, and 616. Environment 600 may include a greater number of virtual sub-queues than as illustrated in FIG. 6. Queue management functionality can include: performing operations on a packet (e.g., a compare metric 650 operation, a compute packet virtual time 656 operation, a drop or modify 652 operation, and a read packet virtual time 658 operation); updating or calculating information associated with the queue structure (e.g., a measure virtual time rate 662 operation, a compute aggregate rate 659 operation, a compute fair share ratio 663 operation, and a scale metric 664 operation); and storing information associated with the queue structure (e.g., a global virtual time 660, an amount of resource 654, a sub-queue metric 694, and a scaled metric 696). Global virtual time 660 can correspond to a current global virtual time for the queue structure, while sub-queue metric 694 can correspond to some metadata stored in sub-queue 608.

In environment 600, a packet 602 can be received by classifier 604 (depicted by an arrow 670). Classifier 604 can classify packet 602 by assigning a class to packet 602, to be processed by the corresponding virtual sub-queue (depicted by an arrow 672). Upon arrival of packet 602 at the queue structure (i.e., upon processing by virtual sub-queue 608 for placement into FIFO 610 after classification, depicted by an arrow 673), the system can perform compare metric 650 operation. The system can perform congestion management (e.g., AQM or DBM) by comparing scaled metric 696 with amount of resource 654 (indicated as an input to compare metric 650 operation by an arrow 698) to determine if the packet can be enqueued into FIFO 610. Scaled metric 696 may be provided based on a previous packet being dequeued from FIFO 610, which triggers updating the global virtual time (stored as 660), measuring the virtual time rate (operation 662), computing the aggregate rate (operation 659), and scaling the metric (operation 664). Scaled metric 696 can effectively be the sub-queue metric 694 rescaled by the inverse of the Fair Share Ratio (computed in operation 663 and indicated as an input to scale metric 664 by an arrow 692). The Fair Share Ratio can indicate the ratio of resource to be allocated to each virtual sub-queue of weight 1.

If the comparison of scaled metric 696 to amount of resource 654 determines that the packet can be enqueued into FIFO 610 (decision 650), the system can compute the packet virtual time (depicted by an arrow 678 to operation 656), as described above in relation to operation 356 of FIG. 3. The system can enqueue the packet into FIFO 610 at the appropriate location (as indicated by an arrow 680).

If the comparison of scaled metric 696 to amount of resource 654 determines that the packet cannot be enqueued into FIFO 610 (decision 650), the system can drop or modify the packet (depicted by an arrow 674 to operation 652). If the system determines to modify the packet (e.g., to mark the ECN-CE value or other flow congestion value), the system can subsequently compute the packet virtual time (depicted by an arrow 676 to operation 656).

Upon the scheduler dequeuing a packet, the system can read the packet virtual time (operation 658), update the global virtual time 660 (depicted by an arrow 686), and forward the packet (depicted by an arrow 684 to a packet 606). The system can use the global virtual time 660 to measure the rate of progress of the virtual times of packets processed or dequeued by the scheduler (depicted by an arrow 690 to operation 662), from which the “fair rate” of the queues may be inferred and which can be roughly the rate of progress of packets processed by the slowest sub-queue. Measure virtual time rate 662 operation can compute the “global virtual time rate” by measuring the global virtual time over a predefined time period. Furthermore, in some instances, the system can compute a rate (i.e., the “aggregate rate”) comprising a progress of packets dequeued by the scheduler over the predefined time period from all the sub-queues, e.g., by performing compute aggregate rate 659 operation based on dequeued packet 606 (depicted by an arrow 685 to operation 659). Compute fair share ratio 663 operation can measure a ratio of global virtual time (the fair rate obtained from operation 662 as depicted by an arrow 691) to the aggregate rate (obtained from operation 659 as depicted by an arrow 687). As described above, this ratio of the fair rate/aggregate rate can be referred to as the Fair Share Ratio. Scale metric 664 operation can thus scale sub-queue metric 694 based on the fair rate and the aggregate rate (i.e., the Fair Share Ratio obtained from operation 663 as depicted by an arrow 692), e.g., by dividing the sub-queue metric by the ratio of fair rate/aggregate rate, which can be represented as scaled metric 696 (e.g., sub-queue metric/fair fate*aggregate rate). As described above, compare metric 650 can use scaled metric 696 against amount of resource 654 to determine how much of the resource should be allocated to each of the virtual sub-queues, which can determine whether a subsequent arriving packet may be enqueued into FIFO 610.

In operations 352, 552, and 652 of, respectively, FIGS. 3, 5, and 6, the system (including components, elements, modules, or units of hardware or software or a combination of hardware and software) may perform other actions relating to the given packet or policies, e.g.: sending a pause frame; sending a flow control signal; sending a flow control packet; changing a policy or procedure related to dropping a packet; modifying a priority associated with the given packet; modifying a Quality of Service (QOS) class associated with the packet, etc.

### ——Virtual Time-Rate Based on Deficit Round Robin

One challenge with the implementation of Virtual-Time Rate is that VTR can be based on SCFQ or STFQ, whereas most network devices may use Deficit Round Robin. Measuring the Virtual-Time rate and the Fair Share Ratio based on a Deficit Round Robin scheduler can be possible. Deficit Round Robin can keep track of the progress of each sub-queue across schedule cycles. Deficit Round Robin can be modified to measure the cumulative progress of each sub-queue over the long term. Similar to SCFQ and STFQ, all congested sub-queues can and do progress at the fair rate. Thus, measuring the progress of a congested queue over time would be sufficient to compute the Virtual-Time rate.

Implementing VTR based on Deficit Round Robin may require selecting a congested sub-queue to be measured. However, as described herein, it can be challenging to determine whether or not a queue is congested, and selecting a sub-queue which is not congested may result in an incorrect Virtual-Time rate. Moreover, the Virtual-Time rate can only be measured and updated when that selected sub-queue is scheduled, which can result in reducing measurement flexibility and freshness. The changes that may be needed to keep track of the cumulative progress of Deficit Round Robin can be intrusive. Thus, in many cases, implementing a virtual STFQ scheduler may provide a better solution than measuring Virtual-Time rate based on Deficit Round Robin.

### ——Self-Contained Virtual-Time Rate

Another challenge with the implementation of Virtual-Time Rate is that VTR is not self-contained like most Dynamic Buffer Management techniques and some Active Queue Management techniques. Using the SCFQ and STFQ schedulers may require adding metadata to each packet in the queue structure, where processing may be performed both at the input of the queues (when packets are added to the queue) and at the output of the queues (when packets are scheduled).

An approximation of STFQ can be implemented as entirely self-contained in output-processing, which can eliminate packet metadata, packet tagging and input processing, and compute packet virtual times as they are dequeued. This may be useful in building a virtual-STFQ when another scheduler already exists and the queue structure cannot be modified. As a result, a self-contained version of the Virtual-Time Rate technique can be implemented and used for Dynamic Buffer Management or Active Queue Management.

When a sub-queue is congested, the system can perform computations of packet virtual time in a predictable manner, e.g., based only on the previous packet in the sub-queue. One difficulty may occur when the queue is not congested: the packet virtual time may be computed from the previous packet or the global virtual time. The scheduler may not have the value of the global virtual time at the time the packet arrived at the queue to make this decision. In order to emulate input processing, a quantum may be used. The quantum should be set to the maximum packet size and can be used to determine whether the packet virtual time should be based on the previous packet or the global time.

The Self-Contained (SC) virtual STFQ can perform the following operations. First, the SC virtual STFQ can determine the sub-queue associated with the packet that was selected by the real scheduler. The SC virtual STFQ can obtain the finish-time of the previous packet in that sub-queue. The finish-time can be retrieved from the STFQ metadata that STFQ uses to track each sub-queue. The SC virtual STFQ can subsequently compute the start-time of the packet. If the finish-time of the previous packet is older than the virtual-time minus the quantum, the start time can be the global virtual-time minus the quantum. Otherwise, the start-time can be the finish-time of the previous packet.

The SC virtual STFQ can then compute the finish-time for that packet, which can be the start-time plus the size of the packet in bytes divided by the weight of the sub-queue. The SC virtual STFQ can store the finish time in the STFQ data associated with the sub-queue. If the start-time of the dequeued packet is greater than the current virtual time, the SC virtual STFQ can set the virtual time to that start-time. The rate of virtual time can then be measured and used to compute the Fair Share.

Virtual-Time Rate with Other Congestion Management Techniques

Virtual-Time Rate can be used with other types of congestion management and with flow control. The dynamic sub-queue threshold sQSi computed by VTR can form the basis of most congestion management and flow control schemes.

Virtual-Time Rate can also be used for most forms of Ethernet flow control, such as per-priority pause and Source Flow Control. For example, if the sub-queue length is greater than sQSi, a pause frame can be sent to reduce the rate of the Ethernet device congesting the sub-queue. More complex techniques can be designed to generate Ethernet pause frames based on Virtual-Time Rate.

Furthermore, while the described aspects depict the Virtual-Time Rate operating in the context of networks and networking systems (as described in relation to FIG. 1), VTR can also be applied outside of networks and networking systems. For example, VTR can be used to manage a queue of requests at a server and provide fairness between request streams. In this case, the sub-queues would not contain packets, but would instead contain requests. The requests can be tagged with a service-tag, and the sizes of the requests would need to be determined. All other VTR could remain the same.

### Method and System for Facilitating Managing Queues Based on a Virtual-Time Rate

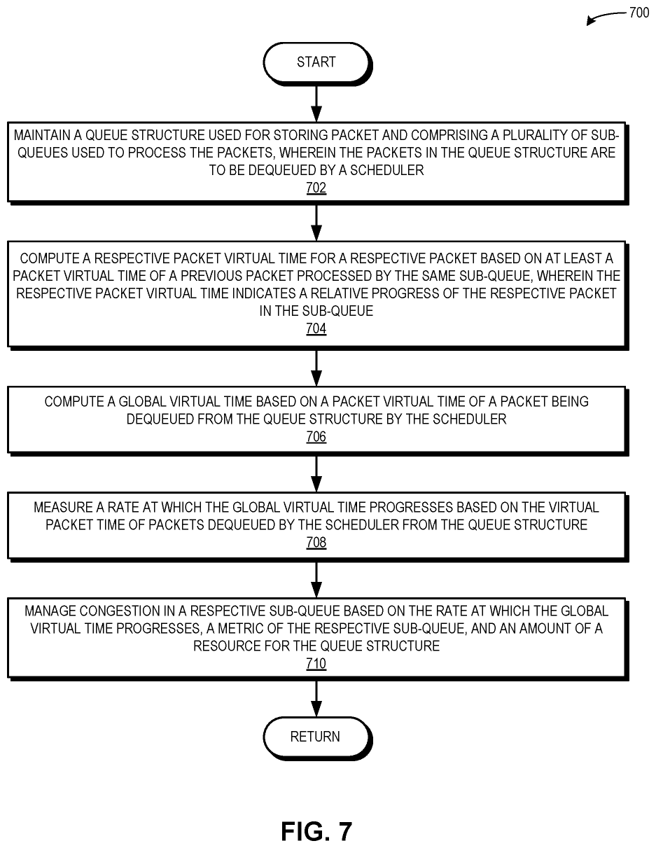

FIG. 7 presents a flowchart 700 illustrating a method which facilitates managing queues based on a virtual-time rate, in accordance with an aspect of the present application. During operation, the system maintains a queue structure used for storing packets and comprising a plurality of sub-queues used to process the packets, wherein the packets in the queue structure are to be dequeued by a scheduler (operation 702). The packets can be stored in at least one of a respective sub-queue or a single common queue (e.g., FIFO/PIFO/AIFO, as described above in relation to FIFO 610 of FIG. 6). The system computes a respective packet virtual time for a respective packet based on at least a packet virtual time of a previous packet processed by the same sub-queue, wherein the respective packet virtual time indicates a relative progress of the respective packet in the sub-queue (operation 704). The packet virtual time can be a start time or a finish time associated with the packet, and the virtual time of the packet may be computed upon being enqueued in the queue structure or dequeued from the queue structure, as described above in relation to, e.g., operations 356, 456, 556, and 656 of, respectively, FIGS. 3-6. In addition, the virtual time of the packet may be read from the packet upon being dequeued from the queue structure, as described above in relation to, e.g., operations 358, 458, 558, and 658 of, respectively, FIGS. 3-6.

The system computes a global virtual time based on a packet virtual time of a packet being dequeued from the queue structure by the scheduler (operation 706). The system measures a rate at which the global virtual time progresses based on the virtual packet time of packets dequeued by the scheduler from the queue structure (operation 708). For example, as described above in relation to FIG. 3, the system can read the packet virtual time of a packet (358), update global virtual time 360, and forward packet 306. Global virtual time 360 can be used to measure the rate of progress of the virtual times of packets processed or dequeued by the scheduler (e.g., 362), and the “fair rate” of the queues may be inferred from the measured rate (e.g., 363) s. The system manages congestion in a respective sub-queue based on the rate at which the global virtual time progresses, a metric of the respective sub-queue, and an amount of a resource for the queue structure (operation 710). For example, as described above in FIG. 3, decision 350 can be performed based on scaled metric 396 and amount of resource 354, where scaled metric 396 is obtained by applying fair share ratio 363 to sub-queue metric 394, and fair share ratio 363 is based on the aggregate rate (359) and the measured virtual time rate (362). The result of decision 350 can manage congestion by determining whether to drop or modify a packet (352) prior to computing the packet virtual time (356 via 376), or whether to directly enqueue the packet by computing the packet virtual time (356 via 378), i.e., without modifying the packet. Decisions 450/550/650 and operations 452/552/652 of, respectively, FIGS. 4-6 can provide other examples of managing congestion based on the rate at which the global virtual time progresses, a metric of the respective sub-queue, and an amount of a resource for the queue structure. The operation returns.

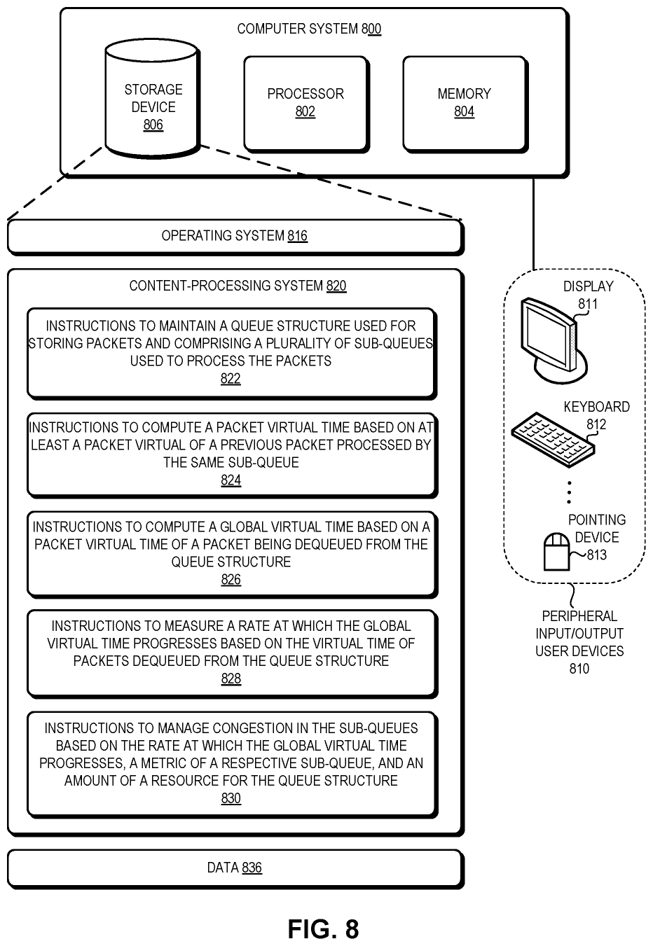

FIG. 8 illustrates a computer system 800 which facilitates managing queues based on a virtual time rate, in accordance with an aspect of the present application. Computer system 800 includes at least one processing resource (e.g., a processor 802), a memory 804, and at least one non-transitory machine-readable storage medium or storage device (e.g., a storage device 806). Memory 804 can include a volatile memory (e.g., RAM) that serves as a managed memory, and can be used to store one or more memory pools. Furthermore, computer system 800 can be coupled to peripheral input/output (I/O) user devices 810 (e.g., a display device 811, a keyboard 812, and a pointing device 813). Storage device 806 can be a non-transitory machine-readable storage device comprising instructions executable by processor 802 to perform and for performing the operations described herein. Storage device 806 can store an operating system 816, a content-processing system 820, and data 836.

Content-processing system 820 can include instructions 822-830 executable by processor 802 to perform methods and/or processes described in this disclosure. Specifically, content-processing system 820 may include instructions for sending and/or receiving data to/from other modules/units/components within computer system 800 or to/from other network nodes across a computer network (not shown).

Content-processing system 820 can further include instructions 822 to maintain a queue structure used for storing packets and comprising a plurality of sub-queues used to process the packets, wherein the packets in the queue structure are to be dequeued by a scheduler. Content-processing system 820 can further include instructions 824 to compute a respective packet virtual time for a respective packet based on at least a packet virtual time of a previous packet processed by the same sub-queue, wherein the respective packet virtual time indicates a relative progress of the respective packet in the sub-queue. Content-processing system 820 can include instructions 826 to compute a global virtual time based on a packet virtual time of a packet being dequeued from the queue structure by the scheduler. Content-processing system 820 can include instructions 828 to measure a rate at which the global virtual time progresses based on the virtual time of packets dequeued by the scheduler from the queue structure. Content-processing system 820 can include instructions 830 to manage congestion in the sub-queues based on the rate at which the global virtual time progresses, a metric of a respective sub-queue, and an amount of a resource for the queue structure.

Content-processing system 820 can additionally include instructions which are not shown in FIG. 8, such as: instructions for classifying, tagging, marking, reading, and modifying a packet, as described above in relation to FIGS. 3-6; instructions for scaling the metric of the respective sub-queue based on the rate at which the global virtual time progresses, comparing the scaled metric of the respective sub-queue with the amount of the resource for the queue structure, and managing the congestion in the respective sub-queue based on the comparison, as described above in relation to operations 350 and 650 of, respectively, FIGS. 3 and 6; and instructions for managing the congestion in the sub-queues based on a length of the respective sub-queue, as described above in relation to operation 450 to FIG. 4. Content-processing system 820 can further include instructions for determining a predicted delay based on the length of the respective sub-queue, computing a probability based on the predicted delay and a configured target delay, and managing the congestion in the respective sub-queue further based on the comparison, as described above in relation to operation 550 of FIG. 5.

Data 836 can include any data that is required as input or that is generated as output by the methods and/or processes described in this disclosure. Specifically, data 836 can store at least: data; a queue structure; a queue; a plurality of sub-queues; a classification; an enqueued packet; a dequeued packet; a virtual time; a packet virtual time; a start time; a finish time; a global virtual time based on a packet virtual time of a packet being dequeued from the queue structure; a sub-queue virtual time; a tail-sub-time; a rate of virtual time of packets dequeued from the queue structure over a predefined time period; a lowest or oldest sub-queue virtual time; a rate at which the global virtual time progresses based on the virtual time of packets dequeued from the queue structure (“global virtual time rate”); an amount of a resource; a metric; a sub-queue metric; a scaled metric; a rate at which packets are dequeued over the predefined time period from a sub-queue corresponding to a lowest sub-queue virtual time; an indicator of dropping a packet, changing an ECN value in a header, transmitting a pause frame, or transmitting a flow control signal or a flow control packet; an indicator of a modification to a packet, packet header, or a policy; a scaled rate; a measured or computed rate; a result of a comparison; an allocated amount of resources; a ratio; a fair share ratio; an virtual time rate; an aggregate time rate; a length of a sub-queue; a predicted delay; a configured target delay; a dynamic threshold; a predefined time period; a byte value; a number of packet buffers; and a delay threshold.

While FIG. 8 depicts computer system 800 with content-processing system 820 and instructions 822-830 which may be implemented in software, the described aspects of the VTR system are not limited to software and may also be implemented in the hardware of an apparatus or a networking device, such as routers and switches. Such an apparatus can comprise a plurality of units or apparatuses which may communicate with one another via a wired, wireless, quantum light, or electrical communication channel. Such an apparatus may be realized using one or more integrated circuits, and may include fewer or more units or apparatuses than those shown in FIG. 8. Further, such an apparatus may be integrated in a computer system, or realized as a separate device which is capable of communicating with other computer systems and/or devices.

Furthermore, instructions 822-830 may be stored in a non-transitory computer-readable storage medium. When instructions 822-830 are executed by a computer or a processing resource, instructions 822-830 can cause the computer or processing resource to perform the methods described herein, including in relation to FIG. 3-7 and content-processing system 820 of FIG. 8. Such a non-transitory computer-readable storage medium may include more instructions than instructions 822-830 of FIG. 8.

### SUMMARY OF IMPROVEMENTS OF THE DESCRIBED ASPECTS

In summary, the described aspects of Virtual-Time Rate can provide improved buffer management in multi-queue systems. Using VTR as described here, a set of buffers can be allocated more efficiently and fairly amongst the sub-queues in comparison with existing solutions. An increased efficiency in the use of the buffers can usually result in an increase in the overall throughput. In addition, the increased efficiency in the use of the buffers can be used to reduce the cost of the network device. Furthermore, VTR may result in a more accurate and fair method of sharing limited resources (e.g., memory buffers) between users of a network, which can result in an increased fairness.

In comparison with a global static threshold, VTR can ensure that each sub-queue cannot use more than its fair share of the buffers. In comparison with a static per-queue threshold, VTR can ensure that most buffers are used. In comparison with previous Dynamic Buffer Management techniques, VTR can improve fairness and reduce complexity. In particular, in VTR, only a single value needs to be measured and only a single threshold needs to be computed.

VTR can also be used to implement Active Queue Management, Flow Control, and other congestion managements schemes. In comparison with existing schemes, VTR can provide a less noisy and more accurate measurement of queuing delay, or VTR can provide a fairer behavior of the congestion management across sub-queues.

### ASPECTS AND VARIATIONS OF THE INSTANT APPLICATION

In general, the disclosed aspects provide a method, computer system, and non-transitory computer-readable storage medium for facilitating managing queues based on a virtual time rates. In one aspect, the system maintains a queue structure used for storing packets and comprising a plurality of sub-queues used to process the packets, wherein the packets in the queue structure are to be dequeued by a scheduler. The system computes a respective packet virtual time for a respective packet based on at least a packet virtual time of a previous packet processed by the same sub-queue, wherein the respective packet virtual time indicates a relative progress of the respective packet in the sub-queue. The system computes a global virtual time based on a packet virtual time of a packet being dequeued from the queue structure by the scheduler. The system measures a rate at which the global virtual time progresses based on the virtual time of packets dequeued by the scheduler from the queue structure. The system manages congestion in a respective sub-queue based on the rate at which the global virtual time progresses, a metric of the respective sub-queue, and an amount of a resource for the queue structure.

In a variation on this aspect, the system manages the congestion in the respective sub-queue by dropping one or more packets.

In a further variation on this aspect, the system manages the congestion in the respective sub-queue by changing an explicit congestion notification (ECN) value in a header of one or more packets.

In a further variation, the system manages the congestion in the respective sub-queue by transmitting a pause frame.

In a further variation, the system manages the congestion in the respective sub-queue by transmitting a flow control signal or a flow control packet.

In a further variation, the system manages the congestion in the respective sub-queue by: scaling the metric of the respective sub-queue based on the rate at which the global virtual time progresses; comparing the scaled metric of the respective sub-queue with the amount of the resource for the queue structure; and managing the congestion in the respective sub-queue based on the comparison.

In yet another variation, the system manages the congestion in the respective sub-queue further based on a length of the sub-queue.

In a further variation, the system determines a predicted delay based on the length of the respective sub-queue. The system computes a probability based on the predicted delay and a configured target delay. The system manages the congestion in the respective sub-queue further based on the probability.

In a further variation, the system computes a dynamic threshold based on the amount of the resource and the measured global virtual time rate. The system compares a current size of the respective sub-queue to the dynamic threshold. The system manages the congestion in the respective sub-queue further based on the comparison.

In a further variation, the amount of the resource comprises at least one of: a byte value; a number of packet buffers; or a delay threshold.

In another aspect, a computer system comprises at least one processing resource and at least one non-transitory machine-readable storage device comprising instructions executable by the at least one processing resource to perform the method as described above, including in relation to FIGS. 3-7 and instructions 822-830 of FIG. 8.

In yet another aspect, a non-transitory computer-readable storage medium comprises instructions executable by a processing resource to perform the method described above, including in relation to FIGS. 3-7 and instructions 822-830 of FIG. 8.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method for managing congestion in a network, the method comprising:
maintaining a queue structure used for storing packets and comprising a plurality of sub-queues used to process the packets, wherein the packets in the queue structure are to be dequeued by a scheduler;
computing a respective packet virtual time for a respective packet based on at least a packet virtual time of a previous packet processed by the same sub-queue, wherein the respective packet virtual time indicates a relative progress of the respective packet in the sub-queue;
computing a global virtual time based on a packet virtual time of a packet being dequeued from the queue structure by the scheduler;
measuring a rate at which the global virtual time progresses based on the virtual time of packets dequeued by the scheduler from the queue structure; and
managing congestion in a respective sub-queue based on the rate at which the global virtual time progresses, a metric of the respective sub-queue, and an amount of a resource for the queue structure.

2. The method of claim 1,
wherein managing the congestion in the respective sub-queue comprises dropping one or more packets.

3. The method of claim 1,
wherein managing the congestion in the respective sub-queue comprises changing an explicit congestion notification (ECN) value in a header of one or more packets.

4. The method of claim 1,
wherein managing the congestion in the respective sub-queue comprises transmitting a pause frame.

5. The method of claim 1,
wherein managing the congestion in the respective sub-queue comprises transmitting a flow control signal or a flow control packet.

6. The method of claim 1, wherein managing the congestion in the respective sub-queue comprises:
scaling the metric of the respective sub-queue based on the rate at which the global virtual time progresses;
comparing the scaled metric of the respective sub-queue with the amount of the resource for the queue structure; and
managing the congestion in the respective sub-queue based on the comparison.

7. The method of claim 1,
wherein managing the congestion in the respective sub-queue is further based on a length of the respective sub-queue.

8. The method of claim 7, further comprising:
determining a predicted delay based on the length of the respective sub-queue;
computing a probability based on the predicted delay and a configured target delay; and
managing the congestion in the respective sub-queue further based on the probability.

9. The method of claim 1, further comprising:
computing a dynamic threshold based on the amount of the resource and the measured global virtual time rate;
comparing a current size of the respective sub-queue to the dynamic threshold; and
managing the congestion in the respective sub-queue further based on the comparison.

10. The method of claim 1, wherein the amount of the resource comprises at least one of:
a byte value;
a number of packet buffers; or
a delay threshold.

11. A computer system, comprising:
at least one processing resource; and
at least one non-transitory machine-readable storage device comprising instructions executable by the at least one processing resource to:
maintain a queue structure used for storing packets and comprising a plurality of sub-queues used to process the packets, wherein the packets in the queue structure are to be dequeued by a scheduler;
compute a respective packet virtual time for a respective packet based on at least a packet virtual time of a previous packet processed by the same sub-queue, wherein the respective packet virtual time indicates a relative progress of the respective packet in the sub-queue;
compute a global virtual time based on a packet virtual time of a packet being dequeued from the queue structure by the scheduler;
measure a rate at which the global virtual time progresses based on the virtual time of packets dequeued by the scheduler from the queue structure; and
manage congestion in the sub-queues based on the rate at which the global virtual time progresses, a metric of a respective sub-queue, and an amount of a resource for the queue structure.

12. The computer system of claim 11,
wherein the instructions to manage the congestion in the sub-queues are further to perform at least one of: drop one or more packets; or change an explicit congestion notification (ECN) value in a header of one or more packets.

13. The computer system of claim 11,
wherein the instructions to manage the congestion in the sub-queues are further to transmit at least one of: a pause frame; a flow control signal; or a flow control packet.

14. The computer system of claim 11, wherein the instructions to manage the congestion in the sub-queues are further to:
scale the metric of the respective sub-queue based on the rate at which the global virtual time progresses;
compare the scaled metric of the respective sub-queue with the amount of the resource for the queue structure; and
manage the congestion in the respective sub-queue based on the comparison.

15. The computer system of claim 11, wherein the instructions to manage the congestion in the sub-queues are further based on a length of the respective sub-queue.

16. The computer system of claim 15, wherein the instructions are further to:
determine a predicted delay based on the length of the respective sub-queue;
compute a probability based on the predicted delay and a configured target delay; and
manage the congestion in the respective sub-queue further based on the probability.

17. The computer system of claim 11, wherein the instructions are further to:
compute a dynamic threshold based on the amount of the resource and the measured global virtual time rate;
compare a current size of the respective sub-queue to the dynamic threshold; and
manage the congestion in the respective sub-queue further based on the comparison.

18. The computer system of claim 11, wherein the amount of the resource comprises at least one of:
a byte value;
a number of packet buffers; or
a delay threshold.

19. A non-transitory computer-readable storage medium comprising instructions executable by a processing resource to:
maintain a queue structure used for storing packets and comprising a plurality of sub-queues used to process the packets, wherein the packets in the queue structure are to be dequeued by a scheduler;
maintain a respective packet virtual time for a respective packet based on at least a packet virtual time of a previous packet processed by the same sub-queue, wherein the respective packet virtual time indicates a relative progress of the respective packet in the sub-queue;
compute a global virtual time based on a packet virtual time of a packet being dequeued from the queue structure by the scheduler;
measure a rate at which the global virtual time progresses based on the virtual time of packets dequeued by the scheduler from the queue structure; and
manage congestion in the sub-queues based on the rate at which the global virtual time progresses, a metric of a respective sub-queue, and an amount of a resource for the queue structure.

20. The non-transitory computer-readable storage medium of claim 19, wherein the instructions to manage the congestion in the respective sub-queue are further to:
scale the metric of the respective sub-queue based on the rate at which the global virtual time progresses;
compare the scaled metric of the respective sub-queue with the amount of the resource for the queue structure; and
manage the congestion in the respective sub-queue based on the comparison.
